(19) United States
(12) Patent Application Publication
(10) Pub. No.: US 2007/0280085 A1
(43) Pub. Date: Dec. 6, 2007

(54) Optical disc device and optical pickup

(75) Inventors: Katsuhiro Seo, Kanagawa (JP); Yoshiki Okamoto, Kanagawa (JP); Noriyuki Kato, Kanagawa (JP)

Correspondence Address: WOLF GREENFIELD & SACKS, P.C., 600 ATLANTIC AVENUE, BOSTON, MA, 02210-2206, US

(73) Assignee: Sony Corporation, Tokyo (JP)

(21) Appl. No.: 11/804,907

(22) Filed: May 21, 2007

(30) Foreign Application Priority Data
May 24, 2006 (JP) JP2006-144294
Dec. 22, 2006 (JP) JP2006-345865

(51) Int. Cl. G11B 7/00

(52) U.S. Cl. 369/112.12

(57) ABSTRACT

An optical disc device performs tracking control using a light amount difference at two overlapping areas. The optical disc device includes a splitter, objective lens, detection-signal generator, tracking-signal generator, and driver. The splitter splits the light beam from a light source into a main beam and sub-beams. The objective lens converges the split beams and illuminates a signal-recording-layer track. The detection-signal generator receives reflected light beams and generates a detection signal according to the reflected-light-beam light amounts. The tracking-signal generator generates a tracking error signal on the basis of the detection signal. The driver drives the objective lens in a tracking direction on the basis of the tracking error signal. The splitter causes the light amounts of the overlapping areas at sub-reflected-light beams to be less than a light amount of an area other than the overlapping areas.

### CROSS REFERENCES TO RELATED APPLICATIONS

The present invention contains subject matter related to Japanese Patent Application JP 2006-144294 and Japanese Patent Application JP 2006-345865 filed in the Japanese Patent Office on May 24, 2006 and Dec. 22, 2006, respectively, the entire contents of which are incorporated herein by reference.

### BACKGROUND OF THE INVENTION

1. Field of the Invention

The present invention relates to an optical disc device and an optical pickup, and is suitable for application to, for example, an optical disk device capable of being used with a plurality of systems.

2. Description of the Related Art

Hitherto, in an optical disc device, a predetermined track is precisely irradiated with a light beam as a result of performing what is called “tracking control.” In the tracking control, a shift in an irradiation position of the light beam with respect to a predetermined track in a signal-recording layer of an optical disc (hereunder referred to as “irradiation shift”) is detected as a tracking error signal, and an optical pickup is moved so as to reduce the irradiation shift to control the irradiation position of the light beam.

Here, as shown in FIG. 1A, protruding grooves G, on which data is recorded, and lands L, which are guide grooves, are alternately disposed at a signal-recording layer of an optical disc 100, and one track is formed by a pair of the groove G and the land L. When the signal-recording layer is irradiated with a light beam, the grooves G and the lands L act as a diffraction grating.

Therefore, when the optical disc device irradiates the optical disc 100 with a light beam in the form of a spot P, the light beam is diffracted by the optical disc 100 and is split into a primary light area AR0, formed by a 0-th order light beam, and secondary light areas AR±1, formed by ±1st order light beams, so that overlapping areas W, where the primary light area AR0 and the secondary light areas AR±1 overlap each other, are formed at both ends of the primary light area AR0.

In the two overlapping areas W, the primary light area AR0 and the secondary light areas AR±1 interfere with each other to change respective light amounts in accordance with the position of the spot P with respect to the groove G and the lands L.

In a push-pull method, as shown in FIG. 1B, a light detector 7 having detection areas 7A and 7B that are divided in two by a division line Cp detects a reflected light spot Q, and, from a detection-light-amount difference ΔQ between the detection light amounts of the detection areas 7A and 7B in accordance with the reflected light spot Q, a tracking error signal STE shown in FIG. 2 can be generated. The tracking error signal STE is a sinusoidal wave representing an overlapping-area light-amount difference ΔW corresponding to the difference between the light amounts of the two overlapping areas W.

The optical disc device may slightly adjust the irradiation position by driving only an objective lens in a tracking direction while an optical pickup is kept fixed. In this case, since the position of the objective lens and the position of the light detector 7 are displaced from each other, as shown in FIG. 3, an offset in which the center of a reflected light spot Q is displaced from a division line Cp of a light detector 8 occurs.

In the push-pull method, it is difficult to determine whether the detection-light-amount difference ΔQ at the detection areas 7A and 7B is due to the offset or due to a change in the overlapping-area light-amount difference ΔW.

To overcome this problem, what is called a “differential push pull (DPP)” method is widely used. In this method, the optical disc 100 is irradiated with a light beam that is split into a main beam (0-th light beam) and sub-beams (±1st order light beams).

Actually, in the DPP method, a light beam emitted from a laser diode is split into a main beam and two sub-beams by a diffraction grating. Then, as shown in FIG. 4A, the optical disc 100 is irradiated with a main spot PA (formed by the main beam) so that the main spot PA is positioned on a predetermined track (actually, a groove G). In addition, it is irradiated with sub-spots PB and PC (formed by the sub-beams) so that the sub-spots PB and PC are positioned at lands L that are displaced by half a track from the predetermined groove G in opposite directions.

As shown in FIG. 4B, in this case, the optical disc device receives, by the light detector 8, a main-reflected-light spot QA, corresponding to the main spot PA, and sub-reflected-light spots QB and QC, corresponding to the sub-spots PB and PC.

The light detector 8 includes a main-spot detecting portion 9 having detection areas 9A, 9B, 9C, and 9D, a sub-spot detecting portion 10 having detection areas 10A and 10B, and a sub-spot detecting portion 11 having detection areas 11A and 11B. The main-spot detecting portion 9 receives the main-reflected-light spot QA, the sub-spot detecting portion 10 receives the sub-reflected-light spot QB, and the sub-spot detecting portion 11 receives the sub-reflected-light spot QC.

At this time, the light amounts of the sub-reflected-light spots QB and QC are small compared to the light amount of the main-reflected-light spot QA, so that the efficiency with which light of the main spot PA is used is increased.

In addition, in the optical disc device, a focus error signal SFE, which represents an amount of shift between a focus of the main beam and the signal-recording layer of the optical disc 100, is generated in accordance with an astigmatism method.

Further, the optical disc device generates detection signals SDa, SDb, SDc, and SDd in accordance with the received light amounts of the detection areas 9A, 9B, 9C, and 9D, and calculates a differential value Sdif of the received light amounts of the areas at both sides of a central line that is parallel to a predetermined track. The calculation is performed in accordance with the following Formula (1). As shown in FIG. 5A, this makes it possible to obtain a sinusoidal wave in which one period is in correspondence with one track in a radial direction of the optical disc 100.
Sdif=(SDa+SDb)−(SDc+SDd) (1)

Incidentally, since the optical disc device generates the focus error signal SFE using the astigmatism method, a light intensity distribution is apparently rotated by 90 orders. Therefore, in the optical disc device, in FIGS. 4A and 4B, the direction of disposition of the main spot PA and the sub-spots PB and PC is vertical, whereas the direction of any division line Cp when the differential value Sdif is calculated in horizontal.

Further, the optical disc device generates detection signals SEa and SEb and detection signals SFa and SFb in. accordance with received light amounts of the detection areas 10A and 10B and received light amounts of detection areas 11A and 11B, respectively. Then, using the following Formula (2), where K1 is a coefficient, it calculates a differential addition value Sds in which a detection-light-amount difference ΔQB (which is a differential value between the detection signals SEa and SEb) is added to a detection-light-amount difference ΔQC (which is a differential value between the detection signals SFa and SFb).
Sds=K1{(SEa−SEb)+(SFa−SFb)} (2)

Incidentally, in the optical disc device, since the light amounts of the sub-spots PB and PC are less than the light amount of the main spot PA, multiplying the predetermined constant K1 to the detection signals SEa, SEb, SFa, and SFb increases the level of the differential addition value Sds to that equivalent to the level of the differential value Sdif.

As shown in FIG. 6, when the reflected-light spot Q is displaced from the center of the light detector 8, an offset occurs in the differential value Sdif, so that, as shown in FIG. 5B, the center of the sinusoidal wave of the differential value Sdif moves.

At this time, as shown in FIG. 5C, the phase of the differential addition value Sds is the reverse of the phase of the differential value Sdif shown in FIG. 5B, and an offset occurs in the differential addition value Sds similarly to the differential value Sdif. This is because, as shown in FIG. 4A, whereas, the optical disc device irradiates the optical disc 100 with the main spot PA so that the main spot PA is positioned on a groove G, it irradiates the optical disc 100 so that the sub-spots PB and PC are positioned at lands L that are displaced by half a track from the predetermined groove G.

To overcome this problem, the difference between the differential value Sdif and the differential addition value Sds is calculated in accordance with the following Formula (3) to, as shown in FIG. 5D, cancel the effect of the offsets and obtain a tracking error signal STE whose amplitude is approximately doubled. Refer to, for example, Japanese Examined Patent Application Publication No. Hei 4-34212.
STE={(SDa+SDb)−(SDc+SDd)}−K1{(SEa−SEb)+(SFa−SFb)} (3)

### SUMMARY OF THE INVENTION

In recent years, optical disc devices which can be used with optical discs of a plurality of types, such as a digital versatile disc (DVD) and Blu-ray Disc (trademark), are becoming widely used.

As shown in FIG. 7, one type among such optical disc devices includes an optical pickup in which two objective lenses 5 (a first objective lens 5A and a second objective lens 5B) are disposed side by side perpendicularly with respect to a radial direction of the optical disc 100.

In such an optical pickup, the first objective lens 5A is disposed on a first movement axial line ML1 passing through a center 100c of the optical disc 100, and the second objective lens 5B is disposed on a second movement axial line ML2 that does not pass through the center 100c.

That is, the first objective lens 5A is moved along the first movement axial line ML1 in the radial direction of the optical disc 100. At this time, as shown in FIG. 8, the first movement axial line ML1 exists on a radius of the optical disc 100. Therefore, on the first movement axial line ML1, an angle (hereunder referred to as “track tangential angle) Ag between a track tangent line TL and a line perpendicular to the first movement axial line is 0 orders and constant.

In contrast, in the optical pickup, the second objective lens 5B (FIG. 7) moves along the second movement axial line ML2 in the radial direction of the optical disc 100. Here, the second movement axial line ML2 does not exist on a radius of the optical disc 100. Therefore, the track tangential angle Ag (FIG. 8) on the second movement axial line ML2 changes with the position of the second objective lens 5B. At an outer peripheral side of the optical disc 100, the track tangential angle Ag is small, whereas, at an inner peripheral side of the optical disc 100, it is large.

Therefore, as shown in FIG. 9A, when the aforementioned DPP method is applied to an optical pickup including two objective lenses 5, as in an optical pickup having only one objective lens, the first objective lens 5A on a radius of the optical disc 100 performs irradiation of a groove G with the main spot PA among the main spot PA and the sub-spots PB and PC, which are split by the diffraction element, and performs irradiation of adjacent lands L with the sub-spots PB and PC with high precision.

However, since, for the second objective lens 5B that does not exist on a radius of the optical disc 100, the track tangential angle Ag on the second movement axial line ML2 changes in accordance with the position of the second objective lens 5B above the disc 100, the irradiation positions of the sub-spots PB and PC are displaced from the lands L as shown in FIG. 9B.

Here, in the aforementioned DPP method, the sub-spots PB and PC are displaced by half a track in opposite directions from the groove G that is irradiated with the main spot PA to make the phases of the detection-light-amount differences ΔQB and ΔQC opposite to the phase of the differential value Sdif of the main-reflected-light spot QA. In addition, the difference between the differential value Sdif and the differential addition value Sds, in which the detection-light-amount differences ΔQB and ΔQC are added to each other, is calculated to cancel only the offsets, so that the overlapping-area light-amount difference ΔW, which represents the difference between the light amounts of the overlapping areas W, is doubled.

Therefore, when the irradiation positions of the sub-spots PB and PC are displaced from the lands L, as shown in FIG. 10, the phases of the detection-light-amount differences ΔQB and ΔQC are shifted from the phase of the differential value Sdif. Since the phase of the differential addition value Sds cannot be made completely opposite to the phase of the differential value Sdif of the main-reflected-light spot QA, the value of the tracking error signal STE is deviated from the doubled value of the overlapping-area light-amount difference ΔW.

In other words, when a track pitch per one track on the movement axial lines ML (that is, the first movement axial line ML1 and the second movement axial line ML2) is TP (FIG. 4A), the differential value Sdif of the main-reflected-light spot QA, indicated in Formula (1), can be represented by the following Formula (4) as a sinusoidal wave including an offset amount σ:
Sdif=sin(2πx/TP)+σ (4)

When separation distances between the sub-spot PB and the main spot PA and between the sub-spot PC and the main spot PA in a radial direction are D, the differential addition value Sds can be represented as a sinusoidal wave by the following Formula (5):
Sds=K1×(sin(2πx(x+D)/TP)+σ)+K1×(sin(2πx(x−D)/TP)+σ) (5)

If the differential value Sdif and the differential addition value Sds are of the same level, when a predetermined coefficient is multiplied, the tracking error signal STE can be represented by the following Formula (6):
STE=(sin(2πx/TP)+σ)−((sin(2πx(x+D)/TP)+σ)+(sin(2πx(x−D)/TP)+σ)/2 (6)

Re-writing Formula (6) gives the following Formula (7):
STE=(1−cos(2πD/TP)×sin(2πx/TP) (7)

From Formula (7), it can be seen that, in the DPP method, when D=TP/2, unless the tracking error signal STE is a maximum value and the separation distance D is a constant value (TP/2), the value of the tracking error signal STE changes.

Here, a change in the track tangential angle Ag at the second movement axial line ML2 in accordance with the position of the second objective lens 5B above the optical disc 100 means that the value of a track pitch TPa on the second movement axial line ML2 changes. To make the tracking error signal STE constant, the value of each separation distance D needs to be controlled at all times so that it changes in accordance with the value of the track pitch Tpa on the second movement axial line ML2. Such a controlling operation is actually difficult to perform.

Therefore, when the DPP method is applied to an optical disc device including two objective lenses 5, the quality of the tracking error signal STE is reduced in accordance with the second objective lens 5B that does not exist on a radius of the optical disc 100.

The present invention is achieved considering the aforementioned points. The present invention tries to propose an optical disc device and an optical pickup which can prevent a reduction in the quality of a tracking error signal even if an objective lens does not exist on a radius of an optical disc.

According to an embodiment of the present invention, there is provided an optical disc device which performs tracking control using a difference between light amounts at two overlapping areas. The two overlapping areas are formed by superimposing both ends of a 0-th order light beam upon ±1st order light beams in reflected light beams, which include sub-reflected-light beams and which correspond to a light beam reflected by an optical disc, as a result of diffraction of the light beam when the light beam illuminating a predetermined track of a signal-recording layer of the optical disc is reflected. The light amount difference occurs in accordance with a position of the light beam with respect to the track. The optical disc device includes a splitter, an objective lens, a detection-signal generator, a tracking-signal generator, and a driver. The splitter splits the light beam emitted from a light source into a main beam and sub-beams, the main beam being used for reading information recorded on the signal-recording layer, the sub-beams being used for the tracking control. The objective lens converges the split light beams and illuminates the track of the signal-recording layer. The detection-signal generator receives the reflected light beams and generates a detection signal in accordance with the light amounts of the reflected light beams. The tracking-signal generator generates a tracking error signal on the basis of the detection signal. The driver drives the objective lens in a tracking direction on the basis of the tracking error signal. The splitter causes the light amounts of the overlapping areas at the sub-reflected-light beams, formed when the sub-beams are reflected by the signal-recording layer, to be less than a light amount of an area other than the overlapping areas.

By virtue of this structure, since a difference between the light amounts of the overlapping areas occurring in accordance with the relationship between the position of the reflected-light beams and a track substantially does not occur in the sub-reflected-light beams, a differential addition value that represents only an offset can be produced from the sub-reflected-light beams.

According to the embodiment of the present invention, since a difference between the light amounts of the overlapping areas occurring in accordance with the relationship between the position of the reflected-light beams and a track substantially does not occur, a differential addition value that represents only an offset can be produced from the sub-reflected-light beams. Accordingly, even if an objective lens does not exist on a radius of the optical disc, it is possible to provide an optical disc device and an optical pickup which can prevent a reduction in the quality of the tracking error signal.

### BRIEF DESCRIPTION OF THE DRAWINGS

FIGS. 1A and 1B are schematic diagrams illustrating a related reflected-light spot;

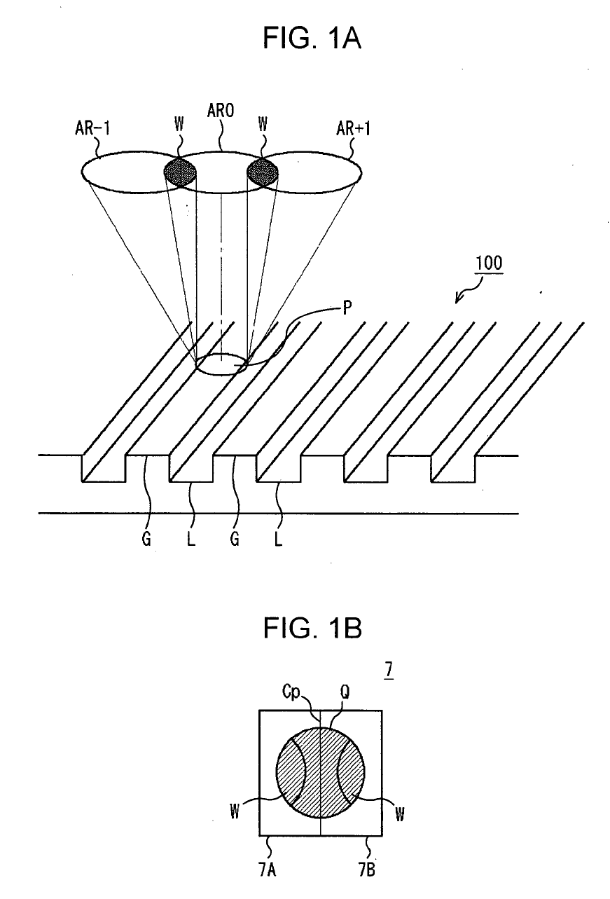

FIG. 2 is a schematic diagram of a tracking error signal in a related push-pull method;

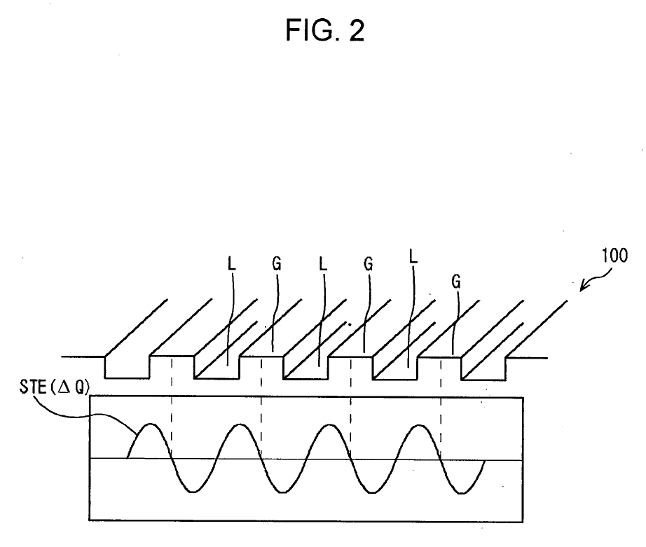

FIG. 3 is a schematic diagram of an offset in the related push-pull method;

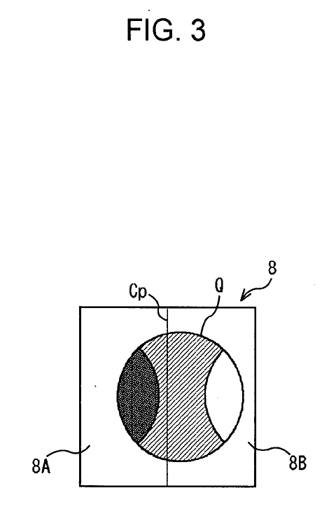

FIGS. 4A and 4B are schematic diagrams illustrating spots and reflected-light spots based on a related DPP method;

FIGS. 5A to 5D are schematic diagrams illustrating generation of a related tracking error signal;

FIG. 6 is a schematic diagram illustrating an offset in the related DPP method;

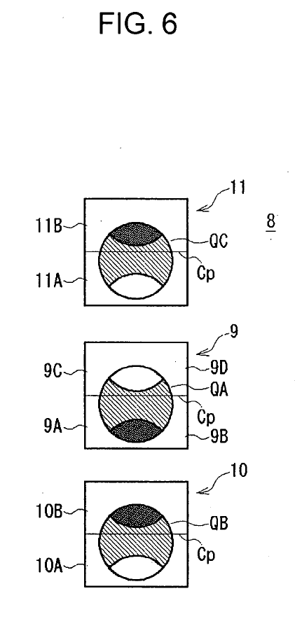

FIG. 7 is a schematic diagram illustrating a disposition of objective lenses in a related optical pickup;

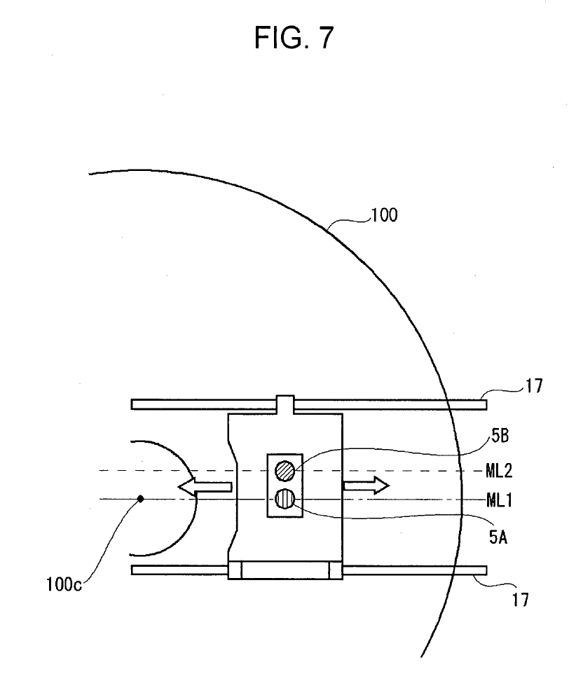

FIG. 8 is a schematic diagram illustrating dependency of a track tangential line on an irradiation position in the related optical pickup;

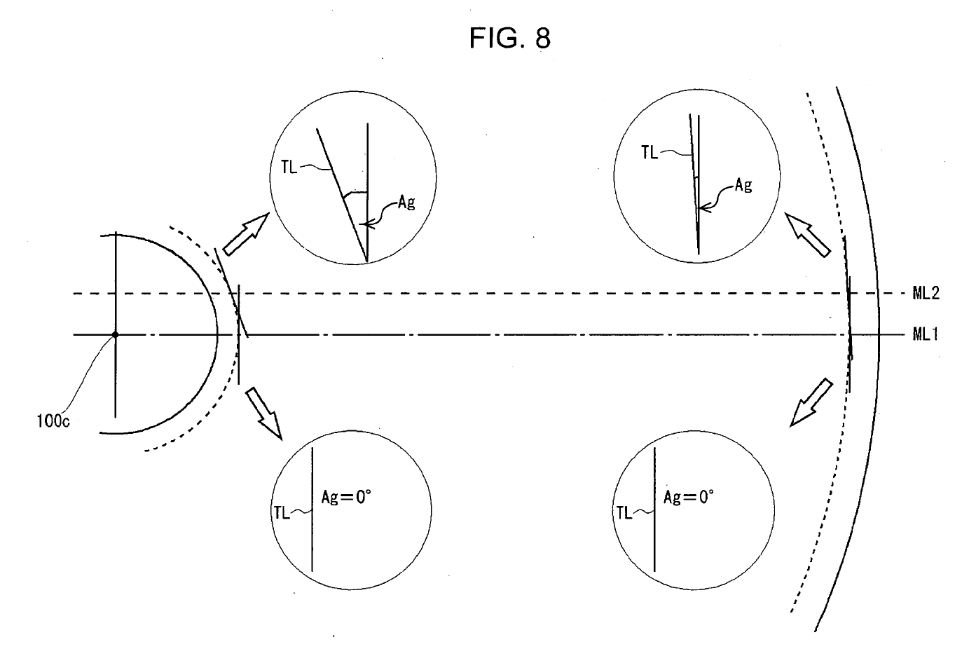

FIGS. 9A and 9B are schematic diagrams illustrating irradiation shift (1) of sub-spots in the related DPP method;

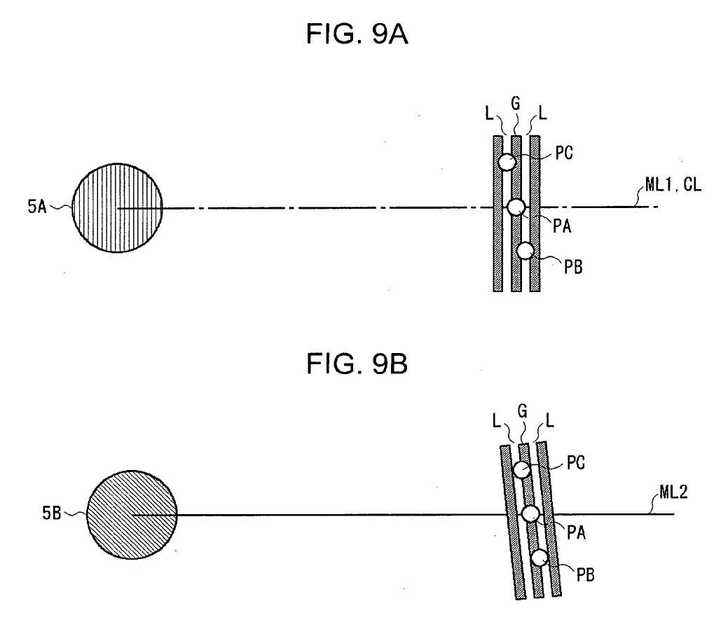

FIG. 10 is a schematic diagram illustrating irradiation shift (2) of the sub-spots in the related DPP method;

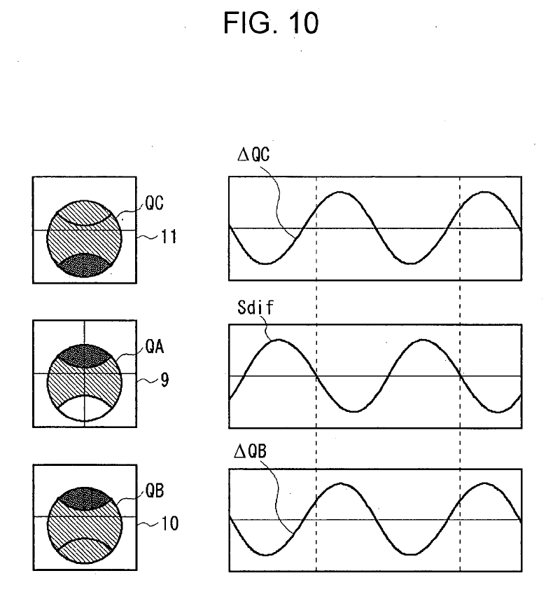

FIG. 11 is a schematic diagram of an entire structure of an optical disc device;

FIG. 12 is a schematic diagram of a structure of an optical pickup;

FIGS. 13A and 13B are schematic diagrams illustrating principles;

FIGS. 14A to 14C are schematic diagrams illustrating generation (1) of a tracking error signal;

FIG. 15 is a schematic diagram of a structure of a diffraction element;

FIG. 16 is a schematic diagram illustrating diffraction of a light beam;

FIG. 17 is a schematic diagram illustrating formation of overlapping areas;

FIGS. 18A and 18B are schematic diagrams illustrating adjustment of a period of an interference pattern;

FIG. 19 is a schematic diagram illustrating shapes of received reflected-light spots;

FIG. 20 is a schematic diagram showing sub-reflected-light beams;

FIG. 21 is a schematic diagram illustrating diffraction of the light beam in a divergent light beam;

FIG. 22 is a schematic diagram showing the sub-reflected-light spot;

FIGS. 23A and 23B are schematic graphs showing the relationship between intersection angle and light amounts of overlapping areas;

FIGS. 24A and 24B are schematic diagrams of a disposition of objective lenses;

FIGS. 25A and 25B are schematic diagrams of spots of a BD light beam;

FIGS. 26A to 26C are schematic diagrams illustrating generation (2) of a tracking error signal;

FIGS. 27A and 27B are schematic diagrams illustrating occurrence of an offset;

FIGS. 28A and 28B are schematic diagrams illustrating offset amounts in accordance with movement of objective lenses;

FIGS. 29A to 29C are schematic diagrams illustrating light-intensity distributions of the sub-reflected-light spots and division lines;

FIGS. 30A and 30B are schematic diagrams illustrating inclination of the division lines in sub-spot detecting portions;

FIGS. 31A to 31C are schematic diagrams illustrating inclination effects of the division lines; and

FIG. 32 is a schematic diagram showing a structure of a diffraction element according to another embodiment.

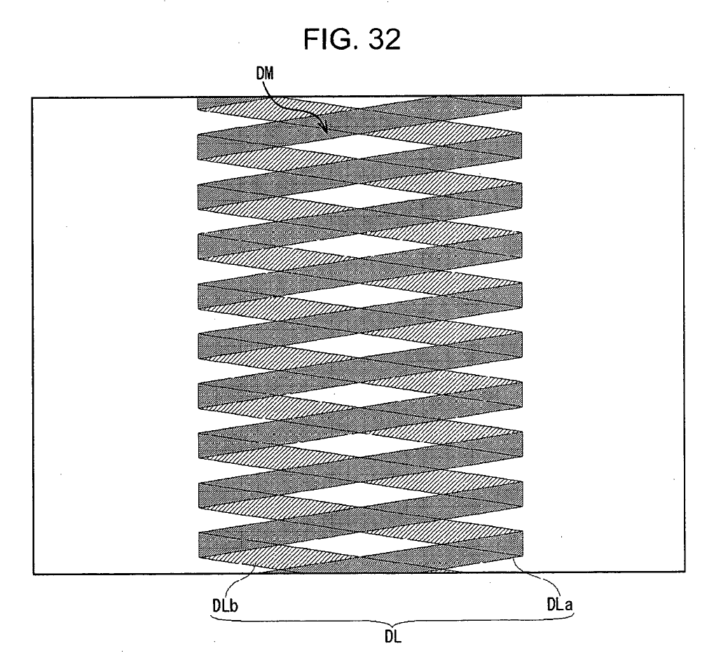

### DESCRIPTION OF THE PREFERRED EMBODIMENTS

An embodiment of the present invention will hereunder be described in detail with reference to the drawings.

(1) Overall Structure of Optical Disc Device

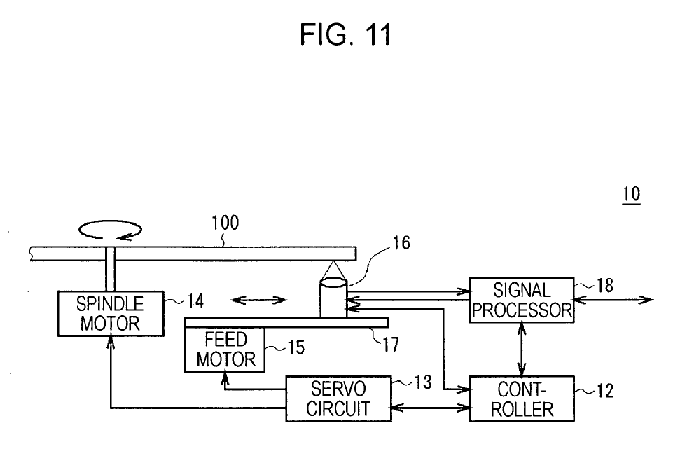

In FIG. 11 in which parts corresponding to those in the related structure are given the same reference numerals, reference numeral 10 denotes an entire optical disc device, and a controller 12 controls each part of the optical disc device 10.

More specifically, the controller 12 rotates a spindle motor 14 through a servo circuit 13 to rotationally drive an optical disc 100 placed on a turntable (not shown). In addition, the controller 12 rotates a feed motor 15 through the servo circuit 13 to move an optical pickup 16 along guide shafts 17 and in a radial direction of the optical disc 100. Further, the controller 12 controls a signal processor 18 to perform reading and writing of data on the optical disc 100.

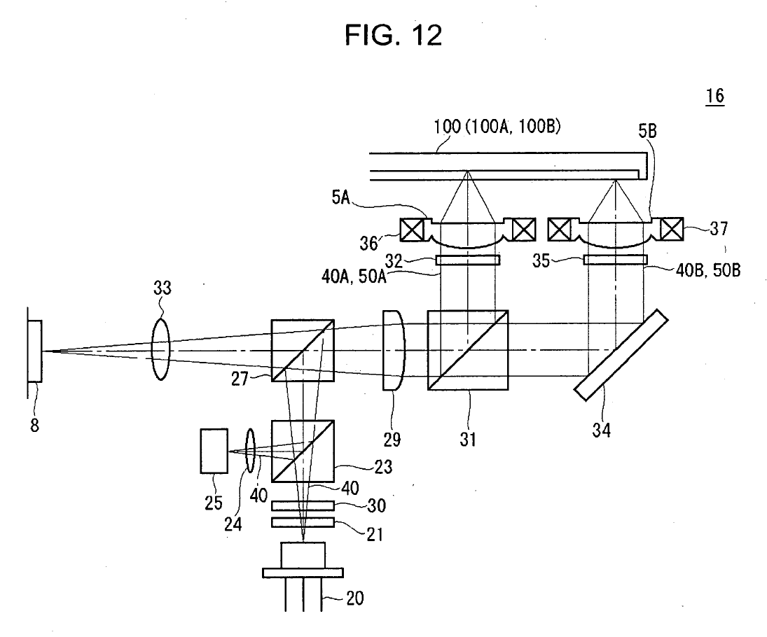

FIG. 12 shows a structure of the optical pickup 16. The optical pickup 16 can be used with two types of optical discs 100, Blu-ray Disc (BD) and a digital versatile disc (DVD). These two types will be referred to as an “optical disc BD100A” and an “optical disc DVD100B,” respectively. The optical pickup 16 includes a BD first objective lens 5A and a DVD second objective lens 5B.

A laser diode 20 emits laser light in accordance with a drive current supplied from the signal processor 18 (see FIG. 11), and causes the laser light to be incident upon a diffraction element 30 as a light beam 40 through a λ/2 wavelength plate 21.

The diffraction element 30 splits the light beam 40 into a main beam MB (which is a 0-th light beam) and sub-beams SB (which are ±1st order light beams). The split light beams are incident upon a beam splitter 23. Incidentally, to increase the efficiency with which the light of the main beam MB for reading recorded information in a signal-recording layer is used, the light amounts of the sub-beams SB are less than the light amount of the main beam MB.

The beam splitter 23 reflects a portion of the light beam 40 at a polarization surface. Then, an auto power control (APC) lens 24 converges this portion of the light beam 40. Thereafter, an APC light detector 25 detects the light amount of this portion of the light beam 40 to generate an exiting-light-amount signal that is in accordance with the light amount, after which the generated signal is supplied to the controller 12 (see FIG. 11).

In addition, the beam splitter 23 (see FIG. 12) transmits the remaining portion of the incident light beam 40, and causes it to be incident upon a collimator lens 29 through a beam splitter 27. The collimator lens 29 converts the light beam 40 incident thereupon as a divergent light beam into a parallel light beam. Then, the parallel light beam is incident upon a beam splitter 31.

The beam splitter 31 either reflects or transmits the incident light beam 40 in accordance with its wavelength. That is, when the light beam 40 is a BD light beam 40A, the beam splitter 31 reflects the BD light beam 40A, changes its direction by 90 orders, and causes the BD light beam 40A to be incident upon the first objective lens 5A through a λ/4 wavelength plate 32. Then, the first objective lens 5A converges the BD light beam 40A to irradiate the optical disc BD100A with the converged BD light beam 40A. In addition, the first objective lens 5A receives a BD reflected light beam 50A, formed by reflecting the BD light beam 40A by the optical disc BD100A, and causes the reflected light beam 50A to be incident upon the beam splitter 31 through the λ/4 wavelength plate 32.

The beam splitter 31 reflects the BD reflected light beam 50A incident thereupon, and changes its direction by 90 orders, so that the BD reflected light beam 50A is incident upon a light detector 8 through the collimator lens 29, the beam splitter 27, and a multi-lens 33 for correcting aberrations. The light detector 8 subjects the BD reflected light beam 50A to photoelectric conversion to generate a detection signal, which is supplied to the signal processor 18 (see FIG. 11).

From the detection signal, the signal processor 18 generates a reproduction RF signal, a focus error signal SFE, and a tracking error signal STE. On the basis of the focus error signal SFE and the tracking error signal STE, supplied from the signal processor 18, the controller 12 generates a drive control signal, and controls a biaxial actuator 36 (see FIG. 12), thereby driving the first objective lens 5A in a focusing direction and a tracking direction so that a predetermined track of the optical disc BD100A is precisely irradiated with the BD light beam 40A.

In contrast, when the light beam 40 is a DVD light beam 40B, the beam splitter 31 transmits the DVD light beam 40B, and causes it to be incident upon a raised mirror 34. The raised mirror 34 changes the direction of the DVD light beam 40B by 90 orders, so that the DVD light beam 40B is incident upon the second objective lens 5B through a λ/4 wavelength plate 35. Then, the second objective lens 5B converges the DVD light beam 40B to irradiate the optical disc DVD100B with the converged DVD light beam 40B. In addition, the second objective lens 5B receives a DVD reflected light beam 50B, formed by reflecting the DVD light beam 40B by the optical disc DVD100B, and causes the reflected light beam 50B to be incident upon the beam splitter 31 through the λ/4 wavelength plate 35 and the raised mirror 34.

The beam splitter 31 transmits the DVD reflected light beam 50B incident thereupon, and causes it to be incident upon the light detector 8 through the collimator lens 29, the beam splitter 27, and the multi-lens 33. Then, the light detector 8 subjects the DVD reflected light beam 50B to photoelectric conversion to generate a detection signal, which is supplied to the signal processor 18 (see FIG. 11).

From the detection signal, the signal processor 18 generates a reproduction RF signal, a focus error signal SFE, and a tracking error signal STE. On the basis of the focus error signal SFE and the tracking error signal STE, supplied from the signal processor 18, the controller 12 generates a drive control signal, and controls a biaxial actuator 37 (see FIG. 12), thereby driving the second objective lens 5B in a focusing direction and a tracking direction so that a predetermined track of the optical disc DVD100B is precisely irradiated with the DVD light beam 40B.

(2) Generation of Tracking Error Signal

(2-1) Principles

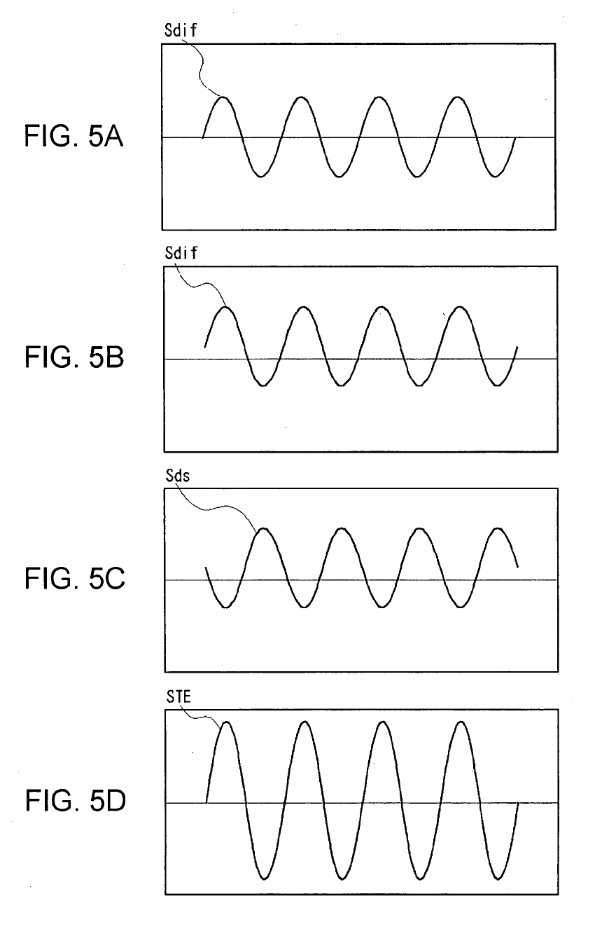

As mentioned above using FIGS. 5A to 5D, in the differential push pull (DPP) method, from the differential value Sdif based on the main-reflected-light spot QA, the differential addition value Sds based on the sub-reflected-light spots QB and QC and having an opposite phase to the differential value Sdif is subtracted. By this calculation, offsets, caused by, for example, the centers of the reflected-light spots being shifted from the light detector 8 by driving only the objective lenses 5, or the optical disc 100 tilting, are canceled, so that the overlapping-area light-amount difference ΔW, which represents the irradiation shift when the main spot PA is shifted from the groove G of a predetermined track, is doubled.

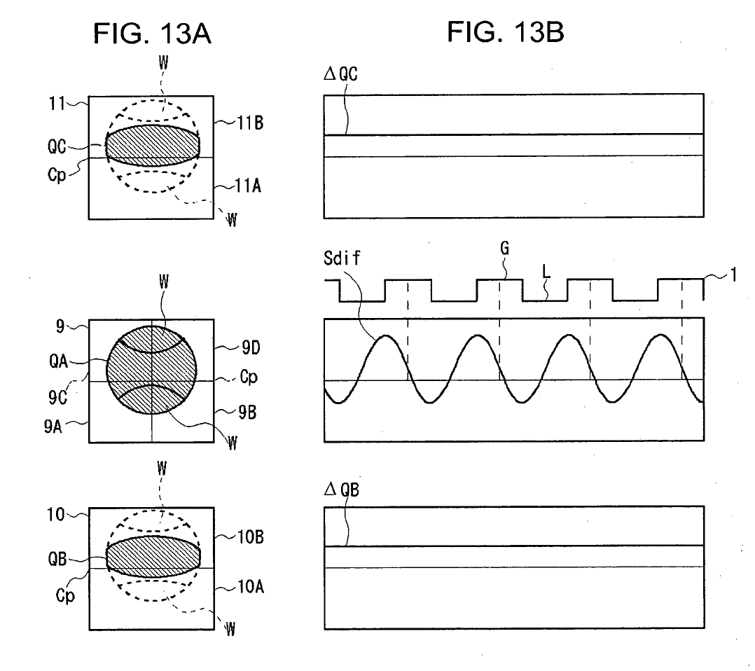

In the embodiment, as in the related art, as shown in FIG. 13A, the overlapping-area light-amount difference ΔW occurs in the main-reflected-light spot QA due to bright and dark portions occurring in the overlapping areas W in accordance with an irradiation shift. In the sub-reflected-light spots QB and QC, the light amounts of the overlapping areas are made less than those of areas other than the overlapping areas W, so that the level of the overlapping-area light-amount difference ΔW, caused by the bright and dark portions (that is, a push-pull component) resulting from an irradiation shift, is made small. By this, the overlapping-area light-amount difference ΔW does not substantially influence the detection-light-amount differences ΔQB and ΔQC (see FIG. 13B).

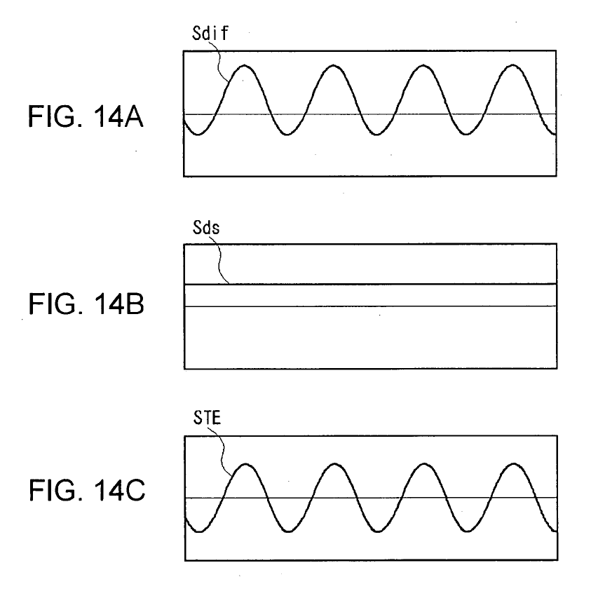

Accordingly, as shown in FIG. 14B, the push-pull component, resulting from an irradiation shift, is removed from the differential addition value Sds, obtained by adding the detection-light-amount differences ΔQB and ΔQC, so that the differential addition value Sds substantially indicates only an offset.

Consequently, the offsets can be canceled as a result of subtracting the differential addition value Sds (see FIG. 14B), which is based on the sub-reflected-light spots QB and QC, from the differential value Sdif (see FIG. 14A), which is based on the main-reflected-light spot QA and calculated on the basis of Formula (2). Therefore, the tracking error signal STE (see FIG. 14C), calculated in accordance with Formula (4), substantially indicates only the overlapping-area light-amount difference ΔW caused by irradiation shift.

(2-2) Structure of Diffraction Element

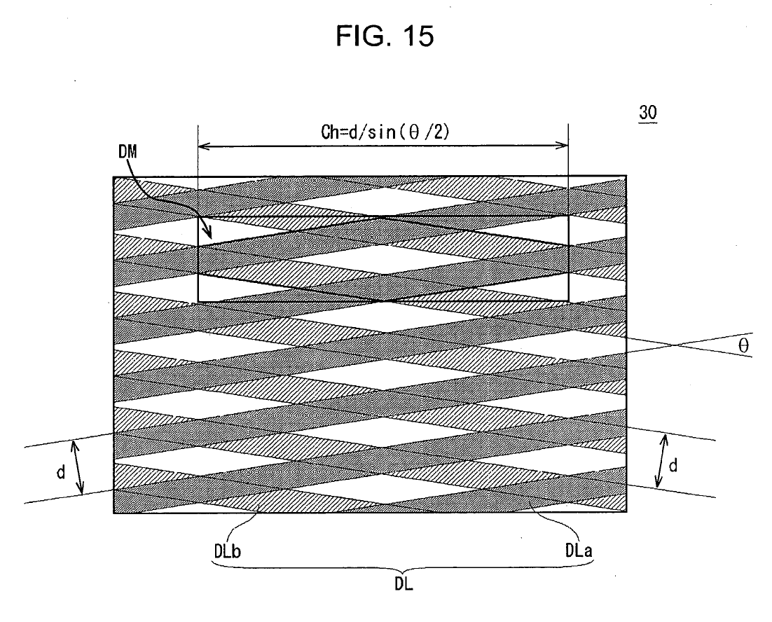

Specifically, the optical pickup 16 splits the light beam 40 into the main beam MB and the sub-beams SB by the diffraction element 30 shown in FIG. 15 so that the light amounts of the overlapping areas W at the sub-reflected-light spots QB and QC are less than those of the areas other than the overlapping areas W.

In the diffraction element 30, a diffraction grating DL formed of, for example, a transparent dielectric film is formed at, for example, a plate element formed of an optical material, such as glass or acrylic resin.

The diffraction grating DL is formed by intersecting a first diffraction grating portion DLa, formed of a pattern of a plurality of straight lines disposed in a parallel period d, and a second diffraction grating portion DLb, similarly formed of a pattern of straight lines disposed in a parallel period d. For example, the first diffraction grating portion DLa and the second diffraction grating portion DLb are provided at one surface of the diffraction element 30 so as to overlap each other.

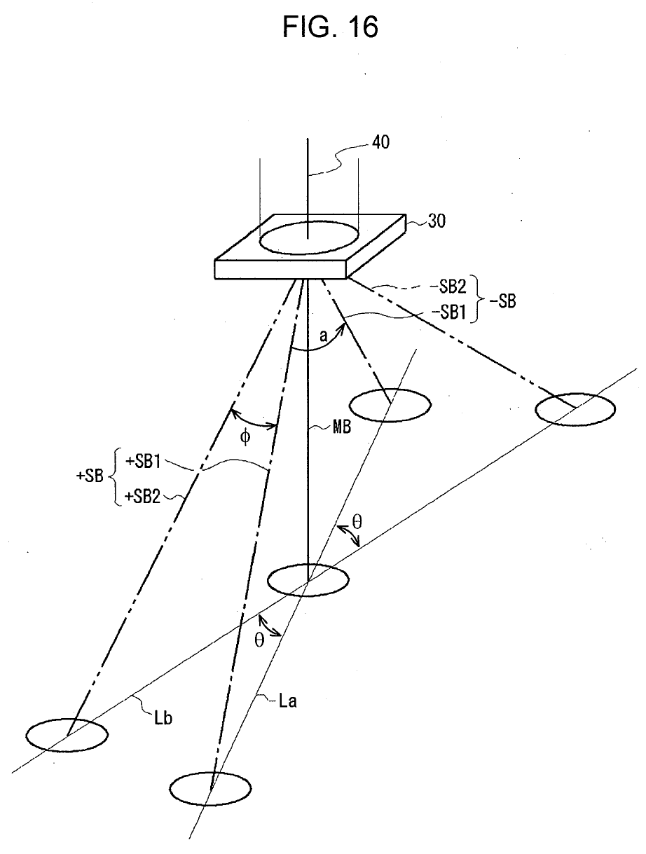

As shown in FIG. 16, the first diffraction grating portion DLa diffracts the incident light beam 40 on a first diffraction line La, so that the light beam 40 is split into the main beam MB and first sub-beams ±SB1, which are ±1st order light beams.

The second diffraction grating portion DLb diffracts the incident light beam 40 on a second diffraction line Lb, so that the light beam 40 is split into the main beam MB and second sub-beams ±SB2, which are ±1st order light beams.

At this time, since the first diffraction grating portion DLa and the second diffraction grating portion DLb (see FIG. 15) of the diffraction element 30 intersect each other at an intersection angle θ, and have the same parallel period d, the first diffraction line La and the second diffraction line Lb intersect each other at the intersection angle θ, and irradiation with the first sub-beams ±SB1 and the second sub-beams ±SB2 is performed so that they are at substantially the same distance from the main beam MB.

At this time, in the diffraction element 30, the intersection angle θ is selected so as to be small (for example, 2.5 orders). Therefore, the first sub-beam +SB1 and the second sub-beam +SB2 (hereunder referred to as “sub-beam +SB”) overlap and interfere with each other, and the first sub-beam −SB1 and the second sub-beam −SB2 (hereunder referred to as “sub-beam −SB”) similarly overlap and interfere with each other. As a result, interference patterns, in which bright and dark portions are repeated in accordance with an adjacent angle φ between the first sub-beam +SB1 and the second sub-beam +SB2 and an adjacent angle φ between the first sub-beam −SB1 and the second sub-beam −SB2, is formed in the sub-beams +SB and −SB.

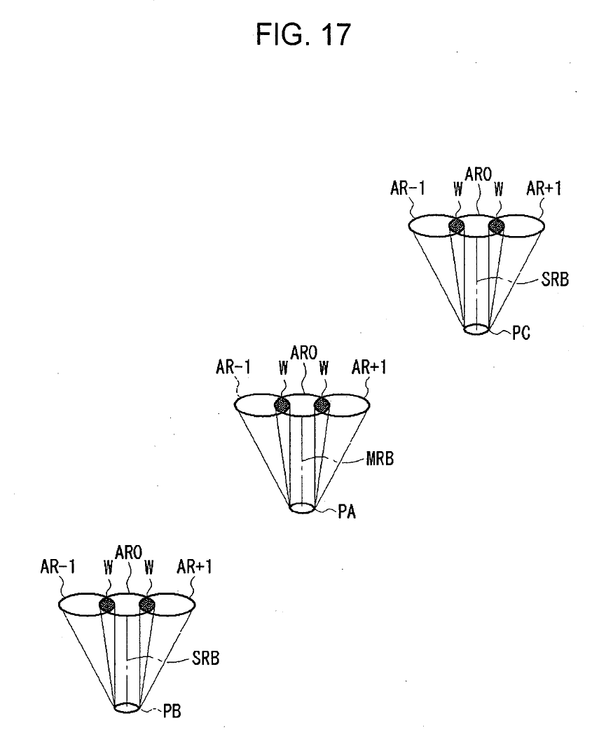

As shown in FIG. 17, the main beam MB and the sub-beams SB (the sub-beams +SB and −SB), illuminating the optical disc 100 through the objective lens 5 as the main spot PA and the sub-spots PB and PC, respectively, are reflected by the optical disc 100, and become a main-reflected-light beam MRB and sub-reflected-light beams SRB.

At this time, the main-reflected-light beam MRB and the sub-reflected-light beams SRB are diffracted by a groove G and lands L, so that they are each split into a primary light area AR0 (formed by a 0-th order light beam) and secondary light areas AR±1 (formed by ±1st order light beams). Therefore, overlapping areas W where the primary light areas AR0 overlap the secondary light areas AR±1 are formed.

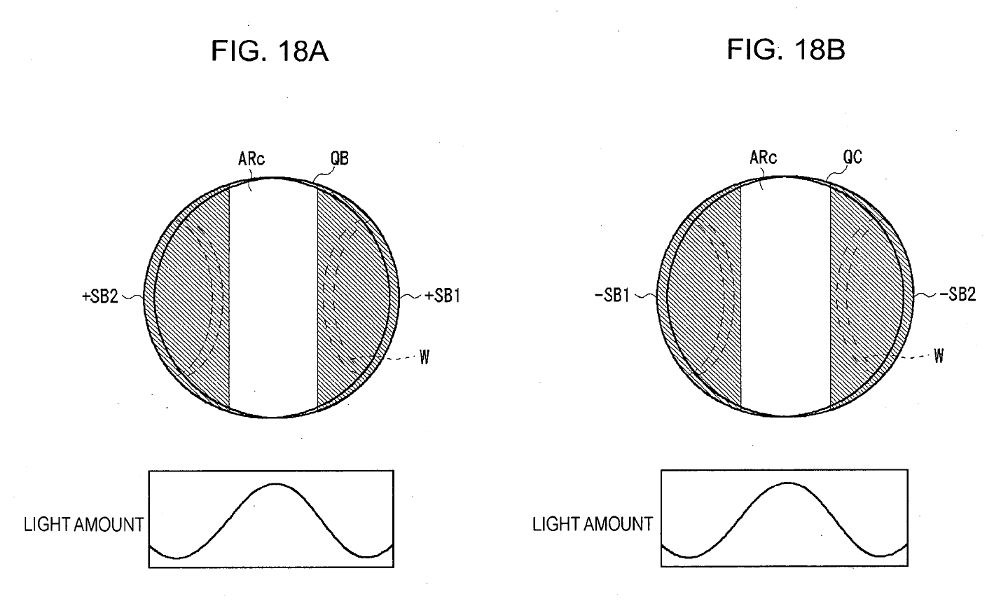

As shown in FIGS. 18A and 18B, the diffraction element 30 according to the embodiment makes it possible for the periods of the interference patterns formed at the aforementioned sub-beams SB to be adjusted so that the dark portions of the interference patterns having small light amounts are situated at areas corresponding to the overlapping areas W formed at the sub-reflected-light spot QB (see FIG. 18A) and the sub-reflected-light spot QC (see FIG. 18B). By this, the light amounts of the overlapping areas W at the sub-reflected-light spots QB and QC are less than those of areas other than the overlapping areas W at the primary light areas AR0. (These areas other than the overlapping areas W will hereunder be called “central areas ARc.”)

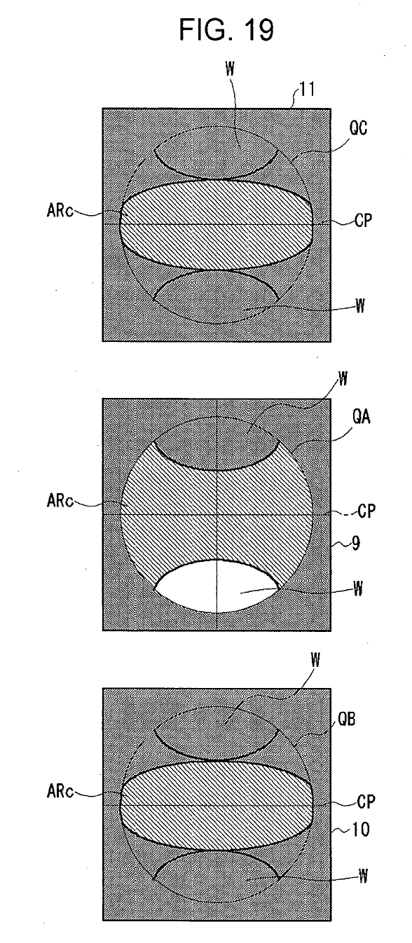

Therefore, as shown in FIG. 19, the diffraction element 30 makes it possible to substantially prevent the bright and dark areas, resulting from an irradiation shift, from appearing at the overlapping areas W. This is because the bright and dark portions, resulting from an irradiation shift as in the related art, appear at the overlapping areas W at the main-reflected-light spot QA received by the main-spot detecting portion 9 of the light detector 8, while the light amounts of the overlapping areas W at the sub-reflected-light spots QB and QC received by the sub-spot detecting portions 10 and 11 are small compared to those of the central areas ARc.

Next, the adjustment of the periods of the interference patterns formed at the sub-beams SB will be described. Although only the sub-beam +SB, the sub-spot PB, and the sub-reflected-light spot QB will be described below, the same applies to the sub-beam −SB, the sub-spot PC, and the sub-reflected-light spot QC.

At the diffraction element 30 shown in FIG. 15, the first diffraction grating portion DLa and the second diffraction grating portion DLb intersect each other to form rhombic portions DM. A horizontal-rhombic-portion period Ch, which is a period in the horizontal direction of the rhombic portions DM, can be represented by the following Formula (8) using the parallel period d of the first diffraction grating portion DLa and the second diffraction grating portion DLb:
Ch=d/sin(θ/2) (8)

Here, when a light amplitude function of the light beam 40 that is incident upon the diffraction element 30 is Fa(x, y), and when coefficients which are not required in the description are eliminated, a light amplitude function Fb(x, y) of the sub-beam +SB can be represented by the following Formula (9):
Fb(x, y)=2×Fa(x, y)×cos(2πx/Ch) (9)

Since the parallel period d is a value that is automatically determined by other factors as described below, by selecting a value for the intersection angle θ and adjusting the horizontal-rhombic-portion period Ch, the period of the interference pattern of the sub-beam +SB can be adjusted so that the dark portions of the interference pattern appear at areas corresponding to the overlapping areas W at the sub-reflected-light beam SRB.

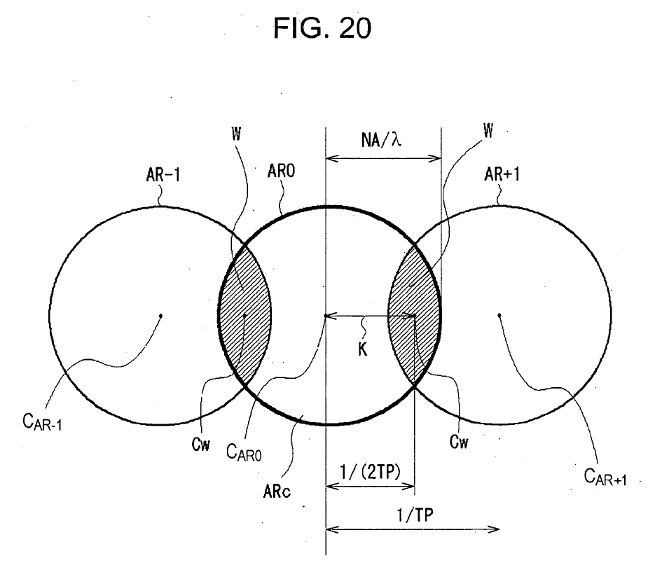

Here, as illustrated in FIG. 20, by adjusting the period of the interference pattern at the sub-beam +SB so that the light amounts near overlapping area centers Cw, which are midway between a center CAR0 of the primary light area AR0 of the sub-reflected-light spot QB and a center CAR+1 of the secondary light area AR+1 and midway between the center CAR0 and a center CAR−1 of the secondary light area AR−1, become equal to or substantially equal to zero, it is possible to reduce the light amounts of the overlapping areas W of the sub-reflected-light beam SRB with maximum efficiency.

More specifically, when the track pitch of the optical disc 100 is TP, the numerical aperture of the objective lenses 5 is NA, the wavelength of the light beam 40 is λ, and the aperture radius of the objective lenses 5 is r, a distance K from the center CAR0 of the primary light area AR0 of the sub-reflected-light spot QB to the center Cw of each overlapping area W can be represented by the following Formula (10):
K=r×λ/(2×TP×NA) (10)

That is, when x=K, it is desirable that the pupil function Fb(x, y) in Formula (9) be substantially zero. Here, a condition under which the value of the pupil function Fb(x, y) becomes zero can be represented by the following Formula (11):
Cos(2πx/Ch)=0 (11)

When the value of (2πx/Ch) is equal to π/2, Formula (11) is established, so that an x value when the pupil function Fb(x, y) becomes zero can be represented by the following Formula (12):
x=¼×Ch (12)

Here, when x=K, and Formula (10) is substituted into Formula (12), the following Formula (13) is established:
2×r×λ=TP×NA×Ch (13)

Further, from a general diffraction grating formula, the angle φ (see FIG. 16; hereunder referred to as the “adjacent beam angle”) between the two +1st order light beams (that is, the first sub-beam +SB1 and the second sub-beam +SB2), diffracted by the diffraction element 30, can be represented by the following Formula (14):
Ch×sin(φ/2)=λ (14)

Here, since φ is a small value, when sin φ approximates to φ, and Formula (14) is substituted into Formula (13), the following Formula (15) is established:
r×φ=TP×NA (15)

Here, when a diffraction angle of the first sub-beam +SB1 and the first sub-beam −SB1 is a, and sin(a) approximates to a, the adjacent beam angle φ is represented by the following Formula (16) using the intersection angle θ:
φ=a×θ (16)

When Formula (16) is substituted into Formula (15), the intersection angle θ can be represented by the following Formula (17):
θ=TP×NA/(r×a) (17)

If the diffraction element 30 exists in a parallel light beam, the parallel period d and the diffraction angle a have a relationship expressed by the following Formula (18):
d×sin(a)=λ (18)

A proper value for the diffraction angle a is selected in accordance with the relationship between the position of the main spot PA and the positions of the sub-spots PB and PC, so that the value of the parallel period d is automatically determined in accordance with the diffraction angle a. When Formula (18) is substituted into Formula (17), the intersection angle θ and the parallel period d are represented by the following Formula (19):
θ=TP×NA×d/(r×λ) (19)

The track pitch TP and the numerical aperture NA are values that are already determined by, for example, a physical condition of the optical disc 100. If a designer determines the aperture radius r so as to satisfy a specification, such as the size of the optical pickup 16, when the intersection angle θ is determined so that Formula (19) is established, the value when x=K in the pupil function Fb(x, y) of Formula (9) is made equal to zero. This makes it possible to efficiently reduce the light amounts of the overlapping areas W at the sub-reflected-light beam SRB.

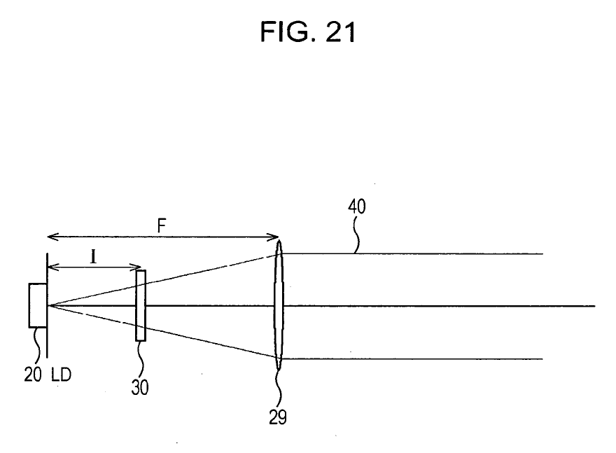

Since, in the embodiment, the diffraction element 30 exists in divergent light, as illustrated in FIG. 21, the parallel period d and the diffraction angle a can be represented by the following Formula (20) using a focal length F of the collimator lens 29 and a distance I from a light source to the diffraction element 30, instead of by Formula (28):
F/I×d×a=λ (20)

Next, when Formula (20) is substituted into Formula (17), the intersection angle θ and the parallel period d in the divergent light are represented by the following Formula (21):
θ=TP×NA×F×d/(I×r×λ) (21)

For the optical pickup 16 in which the diffraction element 30 exists in the divergent light, when an angle close to a value that satisfies Formula (21) is selected as the intersection angle and the period of the interference pattern at the sub-beam +SB is adjusted, the light amounts of the overlapping areas W at the sub-reflected-light spot QB can be made small, so that the influence of an irradiation shift can be eliminated from the differential addition value Sds.

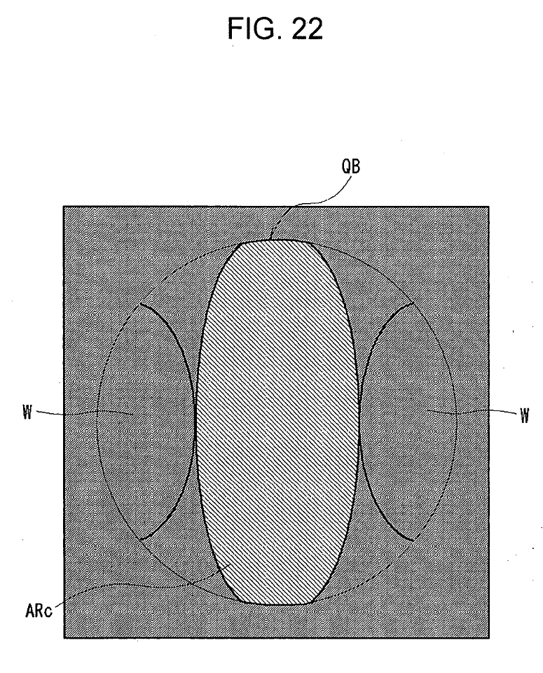

As a result, as shown in FIG. 22, although the sub-reflected-light spot QB received by the light detector 8 causes bright and dark portions, resulting from an irradiation shift, to be produced as a physical phenomenon at the overlapping areas W, the light amounts, themselves, of the overlapping areas W are substantially zero, so that the overlapping-area light-amount difference ΔW is substantially zero. As a result, the detection-light-amount difference ΔQB can primarily reflect only an offset without being subjected to a light-amount modulation of the overlapping-area light-amount difference ΔW.

Accordingly, in the optical disc device 10, the first sub-beams ±SB1 and the second sub-beams ±SB2 overlap each other to form an interference pattern at the sub-reflected-light spot QB. In addition, the intersection angle θ, which determines the period of the interference pattern at the diffraction element 30, is selected so that the dark portions, where the light amounts of the interference pattern become zero, appear near the centers of the overlapping areas W, so that the light amounts at the overlapping areas W can be less than that of the central area ARc.

Incidentally, when the diffraction angle a is equal to 0.31 orders, the optical disc 100 is BD (its track pitch TP=0.32 μm), the numerical aperture NA is equal to 0.85, and λ is equal to 405 nm, the intersection angle θ calculated using Formula (19) is 2.5 orders.

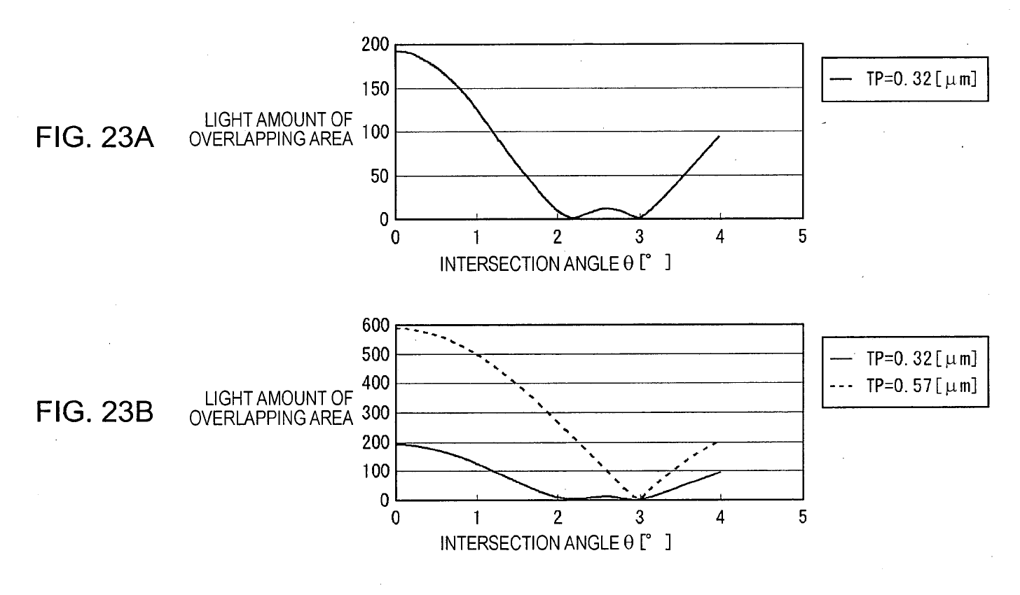

Actually, since, for example, the light beam 40 has a Gauss distribution, the intersection angle θ at which the light amounts of the overlapping areas W are smallest is slightly different from the calculated values as shown in FIG. 23A, so that the light amounts are smallest at approximately 2.2 orders and approximately 2.7 orders.

As shown in FIG. 23B, even if the track pitch TP is equal to 0.57 μm, the intersection angle θ where the light amounts of the overlapping areas W are smallest is near 3 orders. In such a case, when an angle near 3 orders, which provides small light amounts when the track pitch TP is 0.32 μm and 0.57 μm, is selected as the intersection angle θ, the diffraction element 30 can be used for optical discs of different types having different track pitches TP.

In the diffraction element 30 according to the embodiment, values that are close to the value satisfying Formula (21) are selected as the intersection angles θ for the optical discs BD100A and DVD100B. Therefore, the light amounts of the overlapping areas W at the reflected-light spots QB and QC of both the BD light beam 40A and the DVD light beam 40B are made small.

(2-3) Light Reception by Light Detector

Next, the tracking error signal STE that is generated when the optical disc 100 is irradiated with the light beam 40 through the above-described diffraction element 30 will be described.

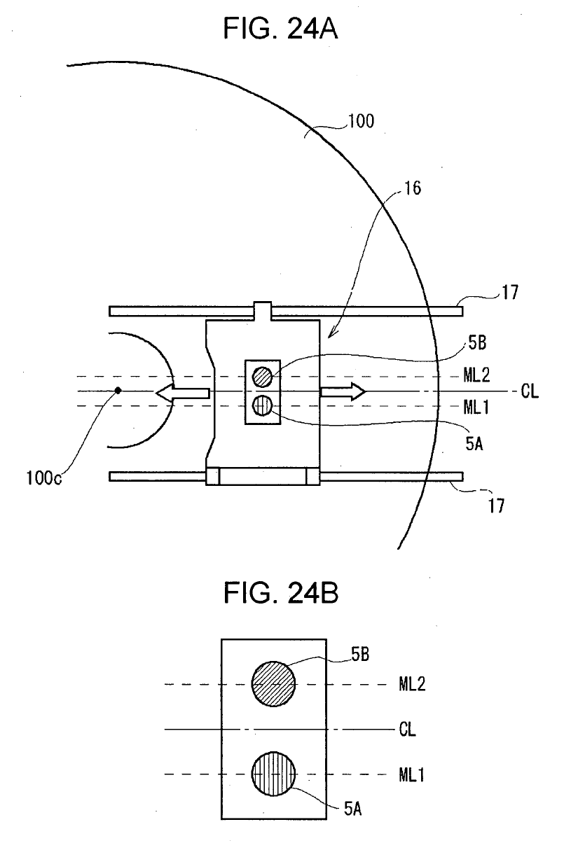

As shown in FIGS. 24A and 24B, in the optical disc device 10, the two guide shafts 17 are installed parallel to a radial direction of the optical disc 100, and the optical pickup 16 is installed so as to be movable along the two guide shafts 17.

In the optical pickup 16, the first objective lens 5A and the second objective lens 5B are disposed substantially symmetrically on respective sides of a central line CL passing through the center 100c of the optical disc 100, and are moved along the first movement axial line ML1 and the second movement axial line ML2, respectively, that do not exist on the central line CL.

Therefore, the optical pickup 16 irradiates the optical disc BD100A with the main spot PA along the first movement axial line ML1, and irradiates the optical disc DVD100B with the main spot PA along the second movement axial line ML2.

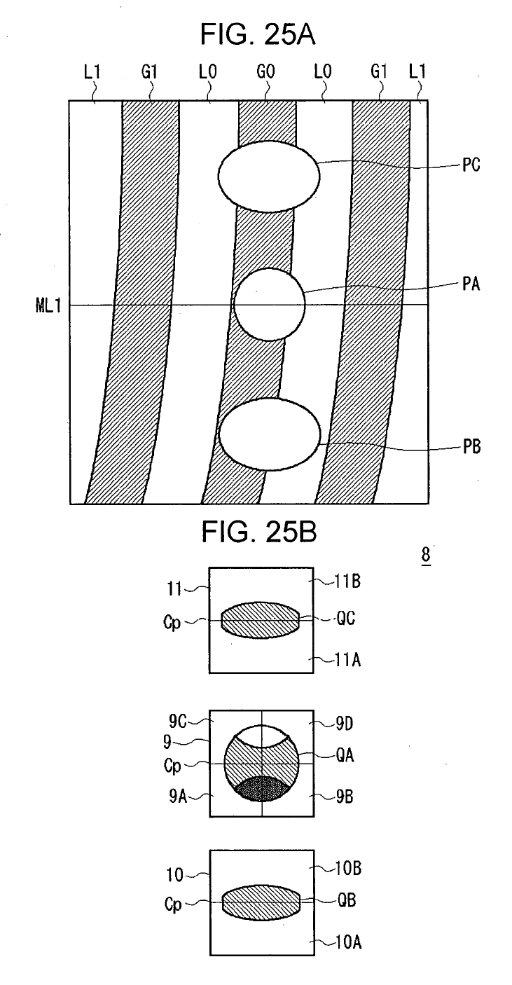

As shown in FIG. 25A, the optical disc device 10 irradiates a groove G0 of a predetermined track of the optical disc BD100A with the main spot PA of the main beam MB, and irradiates the same groove G0 with the sub-spots PB and PC of the sub-beams SB diffracted by the diffraction element 30.

The main beam MB and the sub-beams SB are reflected by the optical disc BD100A, and are received as the main-reflected-light spot QA, the sub-reflected-light spot QB, and the sub-reflected-light spot QC by the light detector 8 including the three spot detecting portions 9, 10, and 11.

Here, since the optical disc device 10 generates the focus error signal SFE using the astigmatism method, the light strength distribution is apparently rotated by 90 orders. Therefore, when the objective lens 5 moves horizontally in the tracking direction, in FIG. 25A and 25B, the main spot PA and the sub-spots PB and PC move horizontally in the tracking direction, whereas the main-reflected-light spot QA and the sub-reflected-light spots QB and QC move vertically in the reflected-light-spot movement direction. Therefore, the division lines Cp in the spot detecting portions 9, 10, and 11 are provided perpendicularly to the spot movement direction.

As shown in FIG. 25B, in the optical disc device 10, the main-spot detecting portion 9 including the detection portions 9A, 9B, 9C, and 9D receive the main-reflected-light spot QA, the sub-spot detecting portion 10 including the detection areas 10A and 10B receive the sub-reflected-light spot QB, and the sub-spot detecting portion 11 including the detection areas 11A and 11B receive the sub-reflected-light spot QC. The optical disc device 10 generates detection signals in accordance with the respective detection areas.

Then, in the optical disc device 10, the detection signals SDc and SDd, which represent the amounts of light received by the detection areas 9C and 9D, are subtracted from the detection signals SDa and SDb, which indicate the amounts of light received by the detection areas 9A and 9B, so that the differential value Sdif, which represents the overlapping-area light-amount difference ΔW and an offset, is calculated in accordance with the following Formula (22):
Sdif=(SDa+SDb)−(SDc+SDd) (22)

Further, in the optical disc device 10, the detection-light-amount difference ΔQB, which is a value resulting from subtracting the detection signal SEb (representing the amount of light received by the detection area 10B) from the detection signal SEa (representing the amount of light received by the detection area 10A), is added to the detection-light-amount difference ΔQC, which is a value resulting from subtracting the detection signal SFb (representing the amount of light received by the detection area 11B) from the detection signal SFa (representing the amount of light received by the detection area 11A). In addition, the light amounts of the sub-reflected-light spots QB and QC are multiplied by a coefficient KA. Accordingly, the differential addition value Sds, which represents an offset, is calculated in accordance with the following Formula (23):
Sds=KA{(SEa−SEb)+(SFa−SFb)} (23)

Next, in the optical disc device 10, the differential addition value Sds, which represents an offset, is subtracted from the differential value Sdif, which represents the overlapping-area light-amount difference ΔW and an offset, so that the tracking error signal STE is calculated in accordance with the following Formula (24):
STE={(SDa+SDb)−(SDc+SDd)}−KA{(SEa−SEb)+(SFa−SFb)} (24)

By this, as illustrated using FIGS. 14A to 14C, the optical disc device 10 can generate the tracking error signal STE, which represents only the overlapping-area light-amount difference ΔW resulting from an irradiation shift, as a result of eliminating the offset from the differential value Sdif.

For example, as shown in FIGS. 25A and 25B, when an irradiation shift occurs due to a displacement of the main spot PA from the center of the groove G0, and the reflected-light spots Q exist at the centers of the respective spot detecting portions 9, 10, and 11, the differential value Sdif represents the overlapping-area light-amount difference ΔW in accordance with the irradiation shift, and the differential addition value Sds, which represents an offset, becomes substantially zero. Therefore, the tracking error signal STE represents the overlapping-area light-amount difference ΔW in accordance with the irradiation shift.

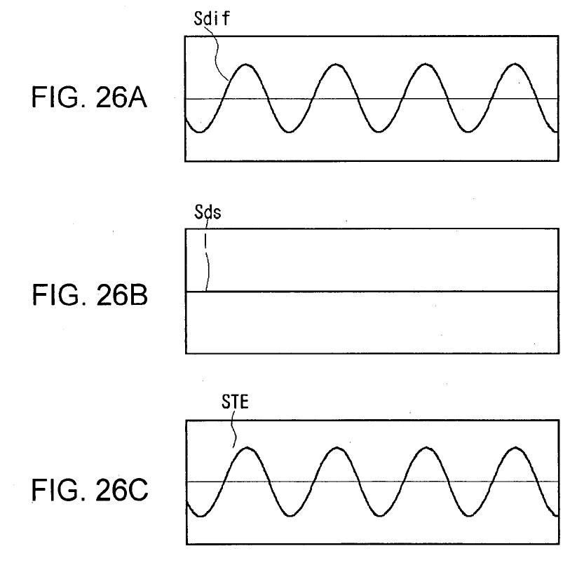

More specifically, when an offset does not substantially occur, as shown in FIG. 26A, the optical disc device 10 can generate a sinusoidal wave as the differential value Sdif that is set when the optical pickup 16 is driven in a radial direction of the optical disc BD100A. One period of the sinusoidal wave is in correspondence with one track in the radial direction of the optical disc BD100A.

As shown in FIG. 26B, at this time, the optical disc device 10 can provide a direct-current component, which indicates that the offset is substantially zero, as the differential addition value Sds.

Therefore, as shown in FIG. 26C, at this time, the optical disc device 10 can provide a sinusoidal wave, having an amplitude that is substantially the same as that of the differential value Sdif, as the tracking error signal STE.

Accordingly, in the optical disc device 10, the light amounts of the overlapping areas W, representing the influence of an irradiation shift, at the sub-reflected-light spots QB and QC are made substantially zero, so that the influence of the irradiation shift is eliminated from the detection-light-amount differences ΔQB and ΔQC. Therefore, the differential addition value Sds, which is the sum of the detection-light-amount differences ΔQB and ΔQC, can represent only the offset without being influenced by the irradiation shift. Therefore, the optical disc device 10 can suitably eliminate the offset from the differential value Sdif even if the objective lenses 5 are not on the central axis CL, so that the tracking error signal STE can be of high quality.

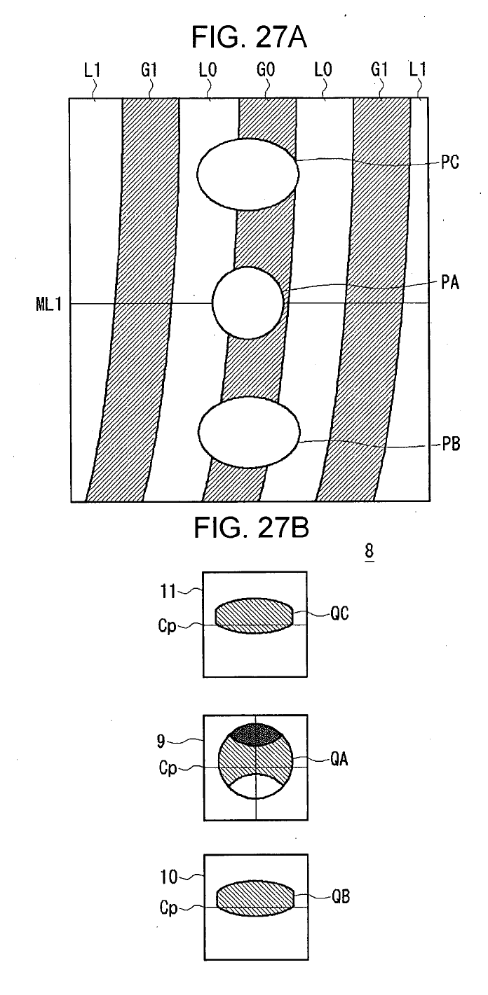

As shown in FIGS. 27A and 27B, when an irradiation shift occurs due to the main spot PA being displaced from the groove G0, and the reflected-light spots Q are displaced from the centers of the respective spot detecting portions 9, 10, and 11, the differential value Sdif represents the offset and the overlapping-area light-amount difference ΔW corresponding to the irradiation shift, and the differential addition value Sds represents only the offset. As a result, when the differential addition value Sds is subtracted from the differential value Sdif, values in accordance with the offsets are cancelled, so that the tracking error signal STE can represent only the overlapping-area light-amount difference ΔW corresponding to the irradiation shift.

In this way, since, in the optical disc device 10, the differential addition value Sds only represents the offset without being influenced by the irradiation shift, it is possible to properly eliminate the offset from the differential value Sdif regardless of the track pitch TP, so that the tracking error signal STE can be of high quality.

In the embodiment, as mentioned above, the intersection angle θ of the diffraction element 30 is selected so that the light amounts of the overlapping areas W at the sub-reflected-light spots QB and QC, formed by the BD light beam 40A and the DVD light beam 40B, are small.

Therefore, even if the optical disc DVD100B having a different tracking pitch TP is used, the optical disc device 10 can generate the tracking error signal STE as in the case where the optical disc BD100A is used.

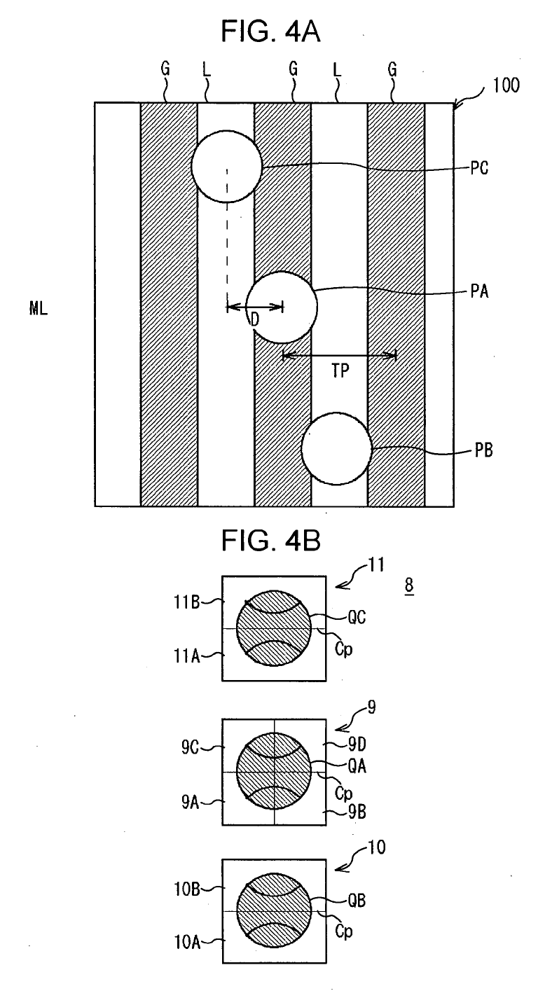

By this, in the optical disc device 10, unlike the case in which the related DPP method is performed, the diffraction element 30 is not adjusted for matching with the track pitch TP the separation distance D (see FIG. 4A) between the main spot PA and the sub-spot PB and the separation distance D (see FIG. 4A) between the main spot PA and the sub-spot PC in accordance with the type of optical disc 100 used.

In the related DPP method, since the light beam 40 is simply split into the main beam MB and the two sub-beams SB, light intensity distributions at the main-reflected-light spot PA and the sub-reflected-light spots PB and PC, which are based on Gauss intensity distributions (that is, push-pull components are not considered), are substantially the same.

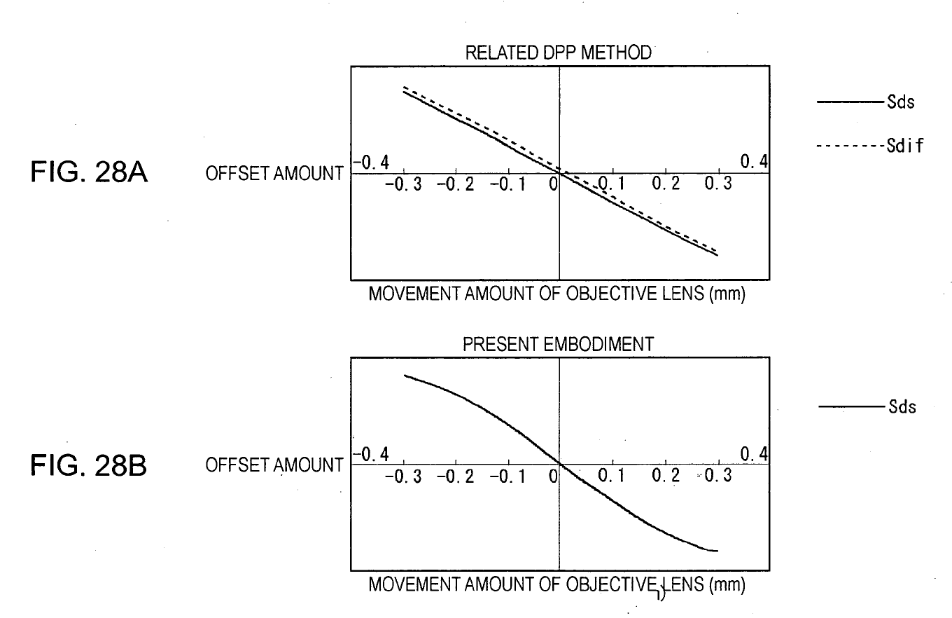

Therefore, as shown in FIG. 28A, like the offset amount of the differential value Sdif, which is calculated on the basis of the main beam MB, the offset amount of the differential addition value Sds, which is calculated on the basis of the sub-beams SB, varies substantially linearly in accordance with the movement amount of the objective lens. By multiplying the predetermined coefficient K1 to the differential addition value Sds, the offset amount value of the differential addition value Sds and the offset amount value of the differential value Sdif can be made substantially the same.

In contrast, in the embodiment, the light beam 40 is split into the main beam MB and the four sub-beams SB, and the first sub-beam +SB1 and the second sub-beam +SB2 and the first sub-beam −SB1 and the second sub-beam −SB2 are made to overlap each other, so that the apparent light intensity distributions of the sub-reflected-light spots PB and PC are changed. For this reason, as shown in FIG. 28B, the offset amount of the differential addition value Sds varies linearly in accordance with the movement amount of the objective lens when the movement amount is small. In contrast, as the movement amount of the objective lens increases, the offset amount of the differential addition value Sds varies with a slight curvature instead of simply linearly in accordance with the movement amount of the objective lens.

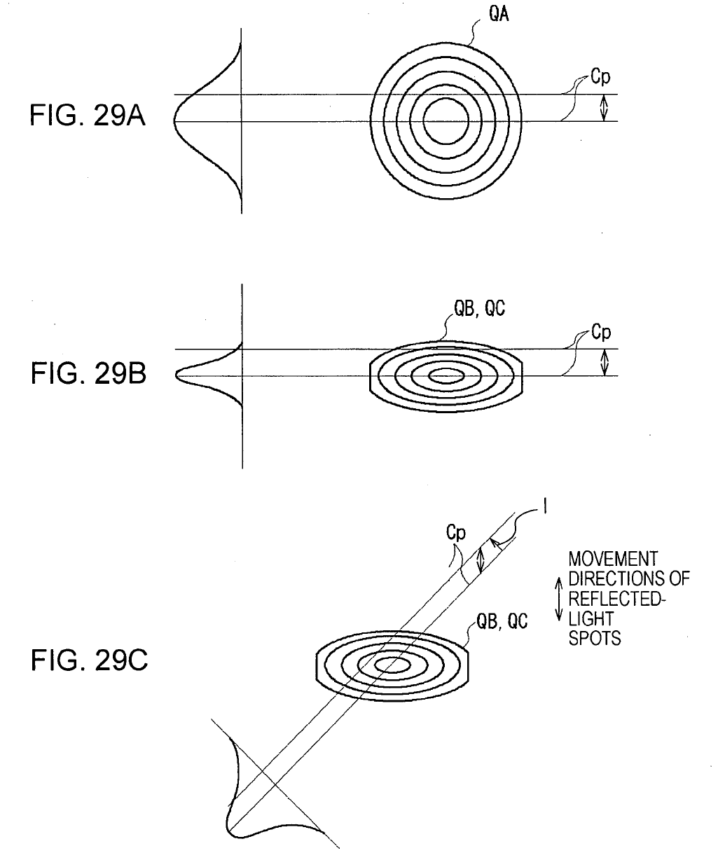

More specifically, as shown in FIGS. 29A to 29C that illustrate, with optical contour lines, the light intensities of the reflected-light spots Q based on Gauss intensity distributions, the shape and light intensity distribution of the main-reflected-light spot QA (see FIG. 29A) of the main beam MB are substantially perfect circles. Accordingly, the interval between the optical contour lines substantially does not change in any direction. Therefore, even if the main-reflected-light spot QA moves, the division line Cp can continue being at a portion of the main-reflected-light spot QA where the light intensity is large.

At the portion where the light intensity is large, the change in the light amount is gradual due to the characteristic of the Gauss intensity distribution, so that the offset amount (see FIG. 28A), represented by the differential value Sdif, changes substantially linearly with respect to the movement amount of the objective lens.

In contrast, the shapes and the light intensity distributions of the sub-reflected-light spots QB and QC (see FIG. 29B) of the sub-beams SB are elliptical due to the formation of interference patterns. The elliptical forms having long axes in the directions of the respective division lines Cp. The intervals between the optical contour lines of the sub-reflected-light spots QB and QC in the directions of movements of the reflected-light spots are less than the interval between the optical contour lines of the main-reflected-light spot QA, so that changes in the light amounts in the directions of movements of the reflected-light spots are abrupt.

Therefore, in the differential addition value Sds (see FIG. 28B), the range in which the offset amount changes linearly with respect to the amount of movement of the objective lens is narrow. Even if the sub-reflected-light spots QB and QC move by the same amount as the main-reflected-light spot QA, the offset amount changes with a curvature with respect to the amount of movement of the objective lens.

As a result, as in the related art, the offset amount in the differential value Sdif changes linearly in accordance with the amount of movement of the objective lens, whereas the offset amount represented by the differential addition value Sds changes with a curvature. Therefore, even if the predetermined coefficient KA is multiplied to the offset amount of the differential addition value Sds, there may be cases in which the offset amount of the differential addition value Sds cannot be made substantially the same as the offset amount of the differential value Sdif.

However, this amount is very small, so that it does not become a practical problem. If the coefficient KA, instead of being constant, changes slightly in accordance with the differential addition value Sds, the offset amount of the differential addition value Sds can be made substantially the same as the offset amount of the differential value Sdif.

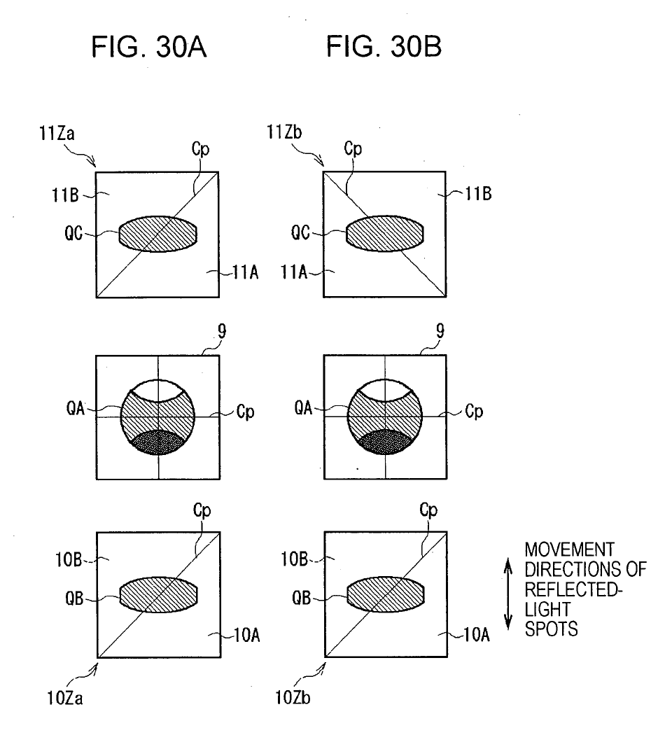

As shown in FIGS. 30A and 30B, division lines Cp at sub-spot detecting portions 10Z and 11Z can be inclined by a predetermined inclination angle from a line perpendicular to the directions of movements of the reflected-light spots. As shown in FIG. 30A, the division lines Cp may be inclined by the same inclination angle in the same direction in sub-spot detecting portions 10Za and 11Za. As shown in FIG. 30B, division lines Cp may be inclined in opposite directions by the same inclination angle in sub-spot detecting portions 10Zb and 11Zb.

By this, as shown in FIG. 29C, the division lines Cp move in an apparently obliquely upward direction 1 with respect to the sub-reflected-light spots QB and QC as the objective lens 5 moves. In the oblique direction 1, the interval between the optical contour lines is large compared to that in the directions of movements of the reflected-light spots, and the amounts of movements of the division lines Cp in the oblique direction 1 are smaller than the actual amounts of movements of the division lines Cp in the directions of movements of the reflected-light spots. Therefore, the changes in the light amounts near the division lines Cp when the sub-reflected-light spots QB and QC move can be made small.

As a result, the differential addition value Sds, which is calculated using the sub-spot detecting portions 10Z and 11Z, can reduce the rate of change of the offset amount with respect to the amount of movement of the objective lens. Therefore, the range in which the offset amount changes linearly can be increased.

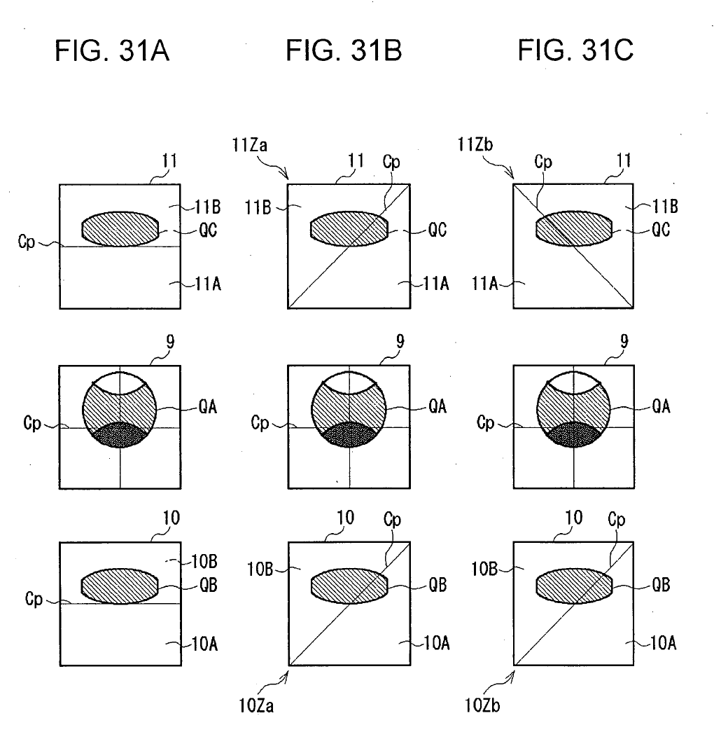

As shown in FIGS. 31A to 31C, even if, in the sub-spot detecting portions 10Z and 11Z (see FIGS. 31B and 31C), the centers of the sub-reflected-light spots QB and QC are greatly shifted from the division lines Cp as a result of the movement of the objective lens 5, the sub-reflected-light spots QB and QC can remain on the division lines Cp. Therefore, compared to the sub-spot detecting portions 10 and 11 (see FIG. 31A) in which the division lines Cp are not inclined, the range of the amount of movement of the objective lens that allows detection of the offset amount can be increased.

Although, in FIGS. 31B and 31C, the inclination angle of the division lines Cp is 45 orders, the inclination angle can be selected as appropriate in accordance with the range of an offset amount to be detected. As the inclination angle increases from 0 orders (see FIG. 31A), the range in which the offset amount of the differential addition value Sds changes linearly and the range of the amount of movement of the objective lens that allows the offset amount to be detected can be increased.

Here, when, in Formula (11), an objective-lens movement amount Δx occurs, x is replaced by (x−Δx). At this time, when the value of (Δx/Ch) is changed to about ¼, the meaning of Formula (11) changes. Therefore, this is not desirable.

However, the actual horizontal-rhombic-portion period Ch in the diffraction element 30 is 3.8 mm, whereas the amount of movement of the objective lens is approximately 0.3 mm at most. Therefore, the value of (Δx/Ch) is 0.3/3.8=approximately 1/12, which is sufficiently small even if the value of (Δx/Ch) is at a maximum, so that no practical problems arise.

(3) Operation and Advantages

In the above-described structure, in the optical disc device 10, the light amounts of the overlapping areas W (where the primary light area AR0 (0-th order light beam) and the ±1st order light beams overlap each other as a result of diffraction of the sub-beam SB by the optical disc 100) at the reflected-light spot QB received by the light detector 8 after the sub-beam SB separated from the light beam 40 is reflected by the signal-recording layer of the optical disc 100 are as follows. That is, the light amounts of the overlapping areas W are less than those of the central areas ARc, which are areas other than the overlapping areas W at the primary light area AR0.

Therefore, the light amounts of the overlapping areas W of the sub-reflected-light spot QB received by the light detector 8 substantially do not change regardless of the position of the sub-spot PB of the sub-beam SB, illuminating the optical disc 100, with respect to a track. Consequently, the detection-light-amount difference ΔQB on both sides of the division line Cp for the sub-reflected-light spot QB received by the main-spot detecting portion 10 can typically substantially represent only the offset.

As a result, in the optical disc device 10, when the differential addition value Sds, which is based on the detection-light-amount difference ΔQB of the sub-reflected-light spot QB, is subtracted from the differential value Sdif, which is based on the detection-light-amount difference of the main-reflected-light spot QA of the main-reflected-light beam, the tracking error signal STE, in which the offset is properly eliminated from the differential value Sdif, can be generated.

Since the position of the sub-spot PB on the track substantially does not influence the detection-light-amount difference ΔQB, unlike the related DPP method, there is no limit as to the irradiation position of the sub-spot PB. Therefore, in the optical disc device 10, the irradiation position of the sub-spot PB is not changed in accordance with the type of optical disc 100 or the position of the objective lens 5. Further, unlike a related optical disc device, the optical disc device 10 is such that the angle of the diffraction element is actually not rotationally adjusted so that irradiation with the optical beam 40 is performed to irradiate lands L with the sub-spot PB.

As a result, since, in the optical disc device 10, tolerance with respect to the setting of the diffraction element 30 can be increased and the objective lenses 5 are not placed on the central line CL of the optical disc 100, it is possible to similarly increase tolerance with respect to the setting of the objective lenses 5, so that the assembly process of the optical pickup 16 can be facilitated.

In the optical disc device 10, the sub-beam SB is split into the first sub-beam +SB1 and the second sub-beam +SB2, and the first sub-beam +SB1 and the second sub-beam +SB2 are made to overlap each other.

Accordingly, since, in the optical disc device 10, an interference pattern can be produced in the first sub-beam +SB1 and the second sub-beam +SB2, the light amounts of the overlapping areas W in the sub-reflected-light spot QB can be made small as a result of only replacing a related diffraction element with the diffraction element 30 having a simple structure.

In the optical disc device 10, the first and second sub-beams overlap each other so that the light amounts become zero near the overlapping area center Cw (midway between the center CAR0 of the primary light area AR0 and the center CAR+1 of the secondary light area AR+1 in the sub-reflected light beam SRB) and near the overlapping area center Cw midway between the center CAR0 of the primary light area AR0 and the center AR−1 of the secondary light area AR−1 in the sub-reflected light beam SRB. Therefore, the light amounts of the overlapping areas W can be efficiently made small.

The diffraction element 30 includes the two-dimensional diffraction grating DL in which the first diffraction grating portion DLa (formed of a pattern of a plurality of straight lines disposed in a predetermined period d) and the second diffraction grating portion DLb (similarly formed of a pattern of straight lines disposed in the parallel period d) intersect each other at a predetermined intersection angle θ.

Accordingly, in the optical disc device 10, the diffraction element 30 having a simple structure splits the light beam 40 into the main beam MB, the first sub-beam +SB1, and the second sub-beam +SB2, and can calculate the intersection angle θ, which determines the period of an interference pattern, by a simple calculation.

Further, in the optical disc device 10, the division line Cp in the sub-spot detecting portion 10 is inclined in accordance with the sub-reflected-light spot QB, so that a change in the offset amount represented by the detection-light-amount difference ΔQB resulting from a change in the light intensity distribution of the sub-reflected-light spot QB is corrected.

Accordingly, in the optical disc device 10, since the offset component can be properly eliminated from the differential value Sdif based on the main-reflected-light spot QA, the quality of the tracking error signal STE can be considerably increased.

According to the above-described structure, the light amounts of the overlapping areas W, where the influence of an irradiation shift (which indicates that the sub-beam SB at the sub-reflected-light beam SRB is shifted from a predetermined track) appears, are made small, so that only the influence of the offset is reflected in the sub-reflected-light beam SRB. Therefore, the differential addition value Sds, which represents only the offset, can be provided from the light amounts of the sub-reflected light beam SRB. Consequently, even if the objective lenses are not on a radius of the optical disc, it is possible to provide an optical disc device and an optical pickup which can prevent the quality of the tracking error signal STE from being reduced.

(4) Other Embodiments

Although, in the above-described embodiment, the first diffraction grating portion DLa and the second diffraction grating portion DLb are formed so as to overlap each other at one surface of the diffraction element 30, the present invention is not limited thereto. For example, the first diffraction grating portion DLa may be formed at one surface, and the second diffraction grating portion DLb may be formed at another surface. Alternatively, it is possible to form protrusions and recessed portions with the same heights and a diffraction pattern so that the first diffraction grating portion DLa and the second diffraction grating portion DLb are formed like one net.

Although, in the above-described embodiment, the diffraction grating DL is formed by forming a thin film on a surface of a substrate of the diffraction element 30 by, for example, sputtering, the present invention is not limited thereto. For example, recesses and protrusions may be integrally formed with the substrate of the diffraction element 30 by molding or by cutting a surface of the substrate of the diffraction element 30. Here, portions where the first diffraction grating portion DLa and the second diffraction grating portion DLb overlap each other are formed with a height that is the same as the height of portions other than the overlapping portions, so that manufacturing of the diffraction element 30 can be facilitated.

Further, although, in the above-described embodiment, the optical disc device includes two objective lenses 5, the present invention is not limited thereto, so that it may include only one objective lens 5.

Further, although, in the above-described embodiment, the light amounts near the overlapping-area centers Cw are zero, the present invention is not limited thereto. The light amounts near the overlapping-area centers Cw may be set small within a range in which influence of an irradiation shift (that is, a push-pull component) of the sub-spot PB substantially does not appear in the overlapping areas W.

Further, although, in the above-described embodiment, the light amounts of the overlapping areas W are made small as a result of forming an interference pattern by superimposing the first sub-beam +SB1 and the second sub-beam SB2, the present invention is not limited thereto. The light amounts of the overlapping areas W may be made small using various other methods.

Further, although, in the above-described embodiment, the diffraction grating DL is formed by intersecting at a predetermined intersection angle θ the first diffraction grating portion DLa (formed of a pattern of a plurality of straight lines disposed in a predetermined period d) and the second diffraction grating portion DLb (similarly formed of a pattern of straight lines disposed in the period d), the present invention is not limited thereto. The diffraction grating DL having various other patterns may be used to split the light beam 40 into the main beam MB, the first sub-beam +SB1, and the second sub-beam +SB2.

Further, although, in the above-described embodiment, the diffraction grating DL is formed over substantially the entire surface of the diffraction element 30, the present invention is not limited thereto. For example, as shown in FIGS. 31A to 31C, the diffraction grating DL is not formed in the areas corresponding to the overlapping areas W of the light beam 40 passing through the diffraction element 30.

Accordingly, when the diffraction element 30 splits the light beam 40 into the main beam MB and the sub-beams SB, it transmits all of the light beam 40 as the main beam MB without diffracting the areas of the light beam 40 corresponding to the overlapping areas W. Therefore, the light amounts of the areas corresponding to the overlapping areas W of the sub-beams SB can be made considerably small.

Further, although, in the above-described embodiment, the optical disc device 10 includes the diffraction element 30 serving as a splitter, the first objective lens 5A, the light receiver 8 serving as a detection-signal generator, the signal processor 18 serving as a tracking signal generator, and the bi-axial actuator 36 serving as a driver, the present invention is not limited thereto. The optical disc device 10 may include a splitter, an objective lens, a detection-signal generator, a tracking controller, and a driver having various other structures.

It should be understood by those skilled in the art that various modifications, combinations, sub-combinations and alterations may occur depending on design requirements and other factors insofar as they are within the scope of the appended claims or the equivalents thereof.

What is claimed is:

1. An optical disc device which performs tracking control using a difference between light amounts at two overlapping areas, the two overlapping areas being formed by superimposing both ends of a 0-th order light beam upon ±1st order light beams in reflected light beams, which include sub-reflected light beams and which correspond to a light beam reflected by an optical disc, as a result of diffraction of the light beam when the light beam illuminating a predetermined track of a signal-recording layer of the optical disc is reflected, the light amount difference occurring in accordance with a position of the light beam with respect to the track, the optical disc device comprising:
a splitter that splits the light beam emitted from a light source into a main beam and sub-beams, the main beam being used for reading information recorded on the signal-recording layer, the sub-beams being used for the tracking control;
an objective lens that converges the split light beams and illuminates the track of the signal-recording layer;
a detection-signal generator that receives the reflected light beams and generates a detection signal in accordance with the light amounts of the reflected light beams;
a tracking-signal generator that generates a tracking error signal on the basis of the detection signal; and
a driver that drives the objective lens in a tracking direction on the basis of the tracking error signal,
wherein the splitter causes the light amounts of the overlapping areas at the sub-reflected-light beams, formed when the sub-beams are reflected by the signal-recording layer, to be less than a light amount of an area other than the overlapping areas.

2. The optical disc device according to claim 1, wherein the splitter splits each sub-beam into a first sub-beam and a second sub-beam, and superimposes the first sub-beam and the second sub-beam of each sub-beam upon each other to form an interference pattern, so that the light amounts of the overlapping areas at the sub-reflected-light beams are made less than the light amount of the area other than the overlapping areas.

3. The optical disc device according to claim 2, wherein the splitter superimposes the first sub-beam and the second sub-beam of each sub-beam so that a light amount near a location that is midway between the center of the 0-th order light beam and the center of the +1st order light beam in each sub-reflected-light beam and a light amount near a location that is midway between the center of the 0-th order light beam and the center of the −1st order light beam in each sub-reflected-light beam become zero.

4. The optical disc device according to claim 1, wherein the splitter includes a diffraction element including a first diffraction grating portion and a second diffraction grating portion, the first and second diffraction grating portions intersecting each other at a predetermined intersection angle, the first diffraction grating portion having a pattern of straight lines disposed at a predetermined period, the second diffraction grating portion similarly having a pattern of straight lines disposed at the predetermined period.

5. The optical disc device according to claim 4, wherein, at the splitter, the intersection angle is selected so that a light amount near a location that is midway between the center of the 0-th order light beam and the center of the +1st order light beam in each sub-reflected-light beam and a light amount near a location that is midway between the center of the 0-th order light beam and the center of the −1st order light beam in each sub-reflected-light beam become zero.

6. The optical disc device according to claim 1, wherein the detection-signal generator has a detection area that receives each sub-reflected-light beam and that is divided into a first detection area and a second detection area by a division line, and wherein the division line is inclined by a predetermined inclination angle from a line perpendicular to a direction of movement of each sub-reflected-light beam when the objective lens moves in the tracking direction corresponding to a radial direction of the optical disc.

7. An optical pickup in an optical disc device that performs tracking control using a difference between light amounts at two overlapping areas, the two overlapping areas being formed by superimposing both ends of a 0-th order light beam upon ±1st order light beams in reflected light beams, which include sub-reflected light beams and which correspond to a light beam reflected by an optical disc, as a result of diffraction of the light beam when the light beam illuminating a predetermined track of a signal-recording layer of the optical disc is reflected, the light amount difference occurring in accordance with a position of the light beam with respect to the track, the optical pickup comprising:
a splitter that splits the light beam emitted from a light source into a main beam and sub-beams, the main beam being used for reading information recorded on the signal-recording layer, the sub-beams being used for the tracking control;
an objective lens that converges the split light beams and illuminates the track of the signal-recording layer;
a detection-signal generator that receives the reflected light beams and generates a detection signal in accordance with the light amounts of the reflected light beams; and
a driver drives the objective lens in a tracking direction on the basis of a tracking error signal generated on the basis of the detection signal,
wherein the splitter causes the light amounts of the overlapping areas at the sub-reflected-light beams, formed when the sub-beams are reflected by the signal-recording layer, to be less than a light amount of an area other than the overlapping areas.
